(19) United States
(12) Patent Application Publication
(10) Pub. No.: US 2010/0202068 A1
(43) Pub. Date: Aug. 12, 2010

(54) LENS BARREL STRUCTURE

(75) Inventor: Daisuke ITO, Osaka (JP)

Correspondence Address: Shinjyu Global IP, 1-4-9 Minamimori-machi, Kita-ku, South Forest Building, 11th Floor, Osaka, 530-0054, JP

(73) Assignee: Panasonic Corporation, Osaka (JP)

(21) Appl. No.: 12/699,047

(22) Filed: Feb. 3, 2010

(30) Foreign Application Priority Data
Feb. 6, 2009 (JP) 2009-025724

(51) Int. Cl. G02B 7/02

(52) U.S. Cl. 359/823

(57) ABSTRACT

A lens barrel structure includes a lens case structure, a first lens group, a movable lens group, and a movable support frame. The movable support frame includes a support frame main body and a first protruding part. The support frame main body includes a first end part that supports the moving lens group and extends in a direction substantially parallel to a first optical axis. The first protruding part is coupled to the first end part and extends in a direction substantially parallel to a second optical axis. The movable support frame is movable with respect to the lens case structure along the second optical axis.

### CROSS-REFERENCE TO RELATED APPLICATIONS

This application claims priority under 35 U.S.C. §119 to Japanese Patent Application No. 2009-025724 filed on Feb. 6, 2009. The entire disclosure of Japanese Patent Application No. 2009-025724 is hereby incorporated herein by reference.

### BACKGROUND

1. Technical Field

The technology disclosed herein relates to a lens barrel structure having a bending optical system.

2. Background Information

Digital cameras that make use of imaging elements have become widely popular in recent years. A digital camera needs to have not only a high pixel count in the imaging element but also improved performance in terms of the lens barrel that forms an optical image on the imaging element. More specifically, there is a need for a lens barrel equipped with a high-power zoom lens system.

In addition to employing a lens barrel equipped with a high-power zoom lens system, there is a need to make the main body smaller in order to make the digital cameras more portable. Accordingly, there is a need for a smaller imaging device comprising a lens barrel and an imaging element. In order to reduce the size of an imaging device, a so-called bending optical system, in which the optical path is bent along the zoom lens system, has been proposed.

In view of the above, it will be apparent to those skilled in the art from this disclosure that there exists a need for an improved lens barrel. This invention addresses this need in the art as well as other needs, which will become apparent to those skilled in the art from this disclosure.

### SUMMARY

An imaging optical system usually has multiple lens groups. These lens groups are housed in a case. Among these multiple lens groups, there is a movable lens group that moves in the optical axis direction relative to a lens frame.

It has been discovered that when the lens frame moves relative to the case, a gap is formed between the lens frame and the case, thereby allowing unnecessary light to pass through the gap and onto the imaging element. As a result, the unnecessary light received by the imaging element causes an adverse effect on the image to be acquired by the imaging element.

Accordingly, aspects of the present invention have been created to solve the above-mentioned problems occurring in the conventional practice, and to prevent at least one of internal reflection and scattering of the light in the lens barrel.

According to one aspect of the present invention, a lens barrel structure includes a lens case structure, a first lens group coupled to the lens case structure to guide light along a first optical axis from a subject to a first direction substantially parallel to a second optical axis that intersects with the first optical axis, a movable lens group housed in the lens case structure, and a movable support frame housed in the lens case structure. The movable support frame includes a support frame main body and a first protruding part. The support frame main body has a first end part configured to movably support the movable lens group and extends in a second direction substantially parallel to the first optical axis. The first protruding part is coupled to the first end part and extends along the first direction. The movable support frame is movable with respect to the lens case structure along the first direction.

These and other features, aspects and advantages of the present invention will become apparent to those skilled in the art from the following detailed description, which, taken in conjunction with the annexed drawings, discloses a preferred and example embodiments of the present invention.

### BRIEF DESCRIPTION

Referring now to the attached drawings which form a part of this original disclosure:

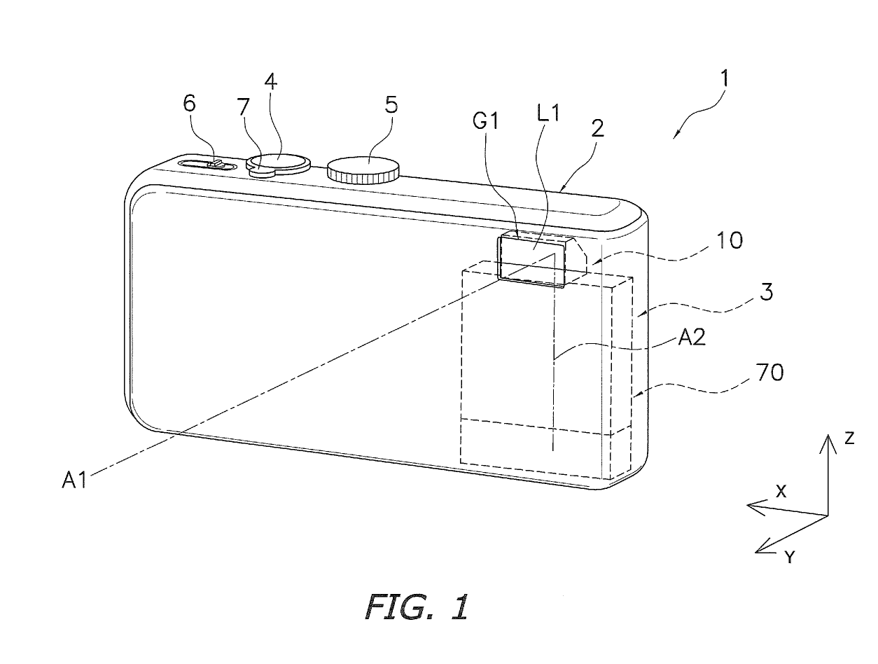

FIG. 1 is a simplified oblique view of a digital camera;

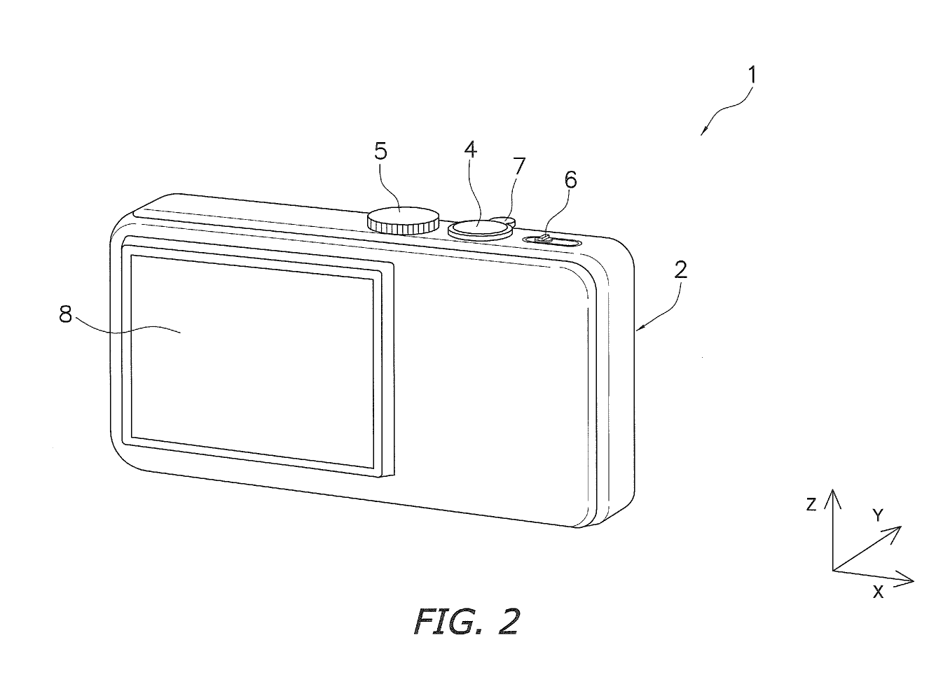

FIG. 2 is a simplified oblique view of the digital camera;

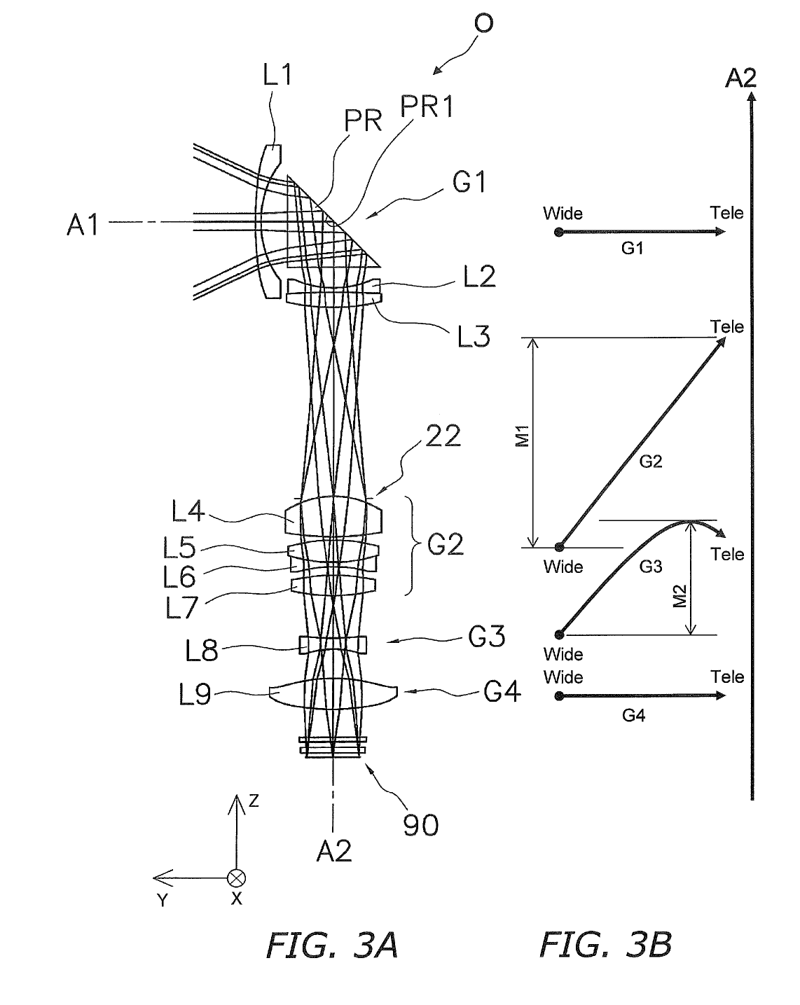

FIG. 3A is a diagram of the configuration of an imaging optical system;

FIG. 3B is a diagram of the movement of the lens groups during zooming;

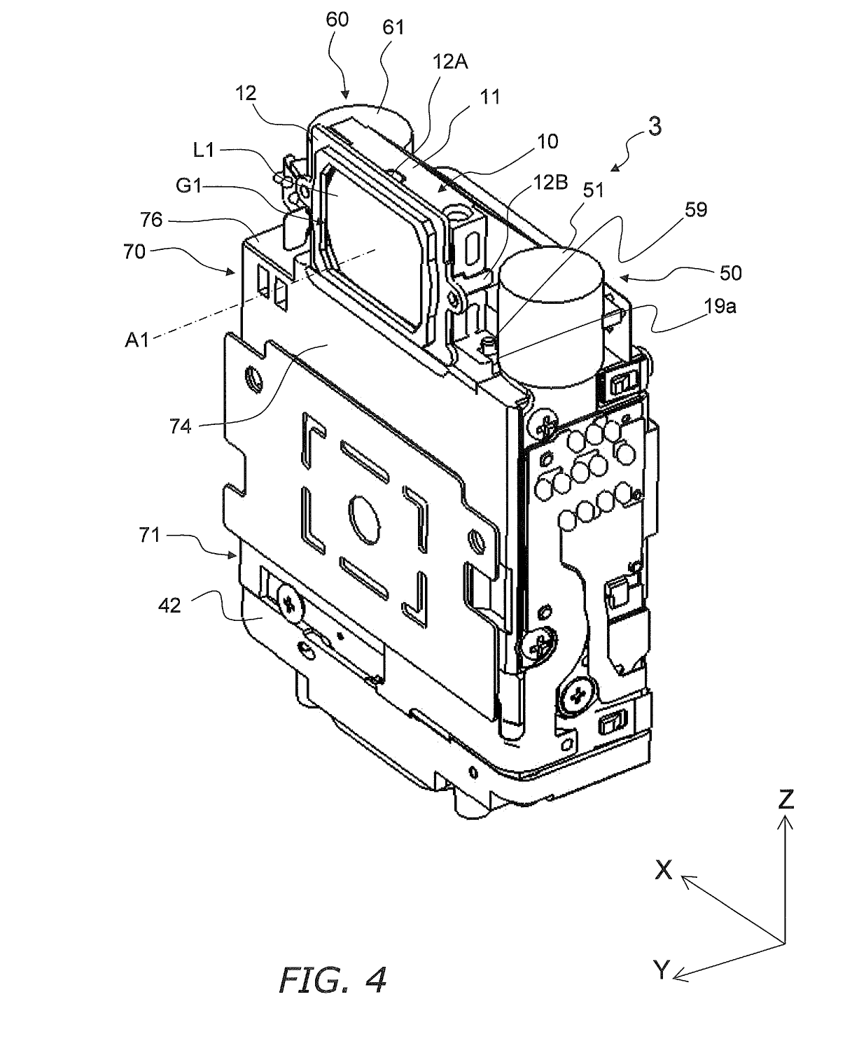

FIG. 4 is an oblique view of a lens barrel from directions in which its front face, top face, and right face can be seen;

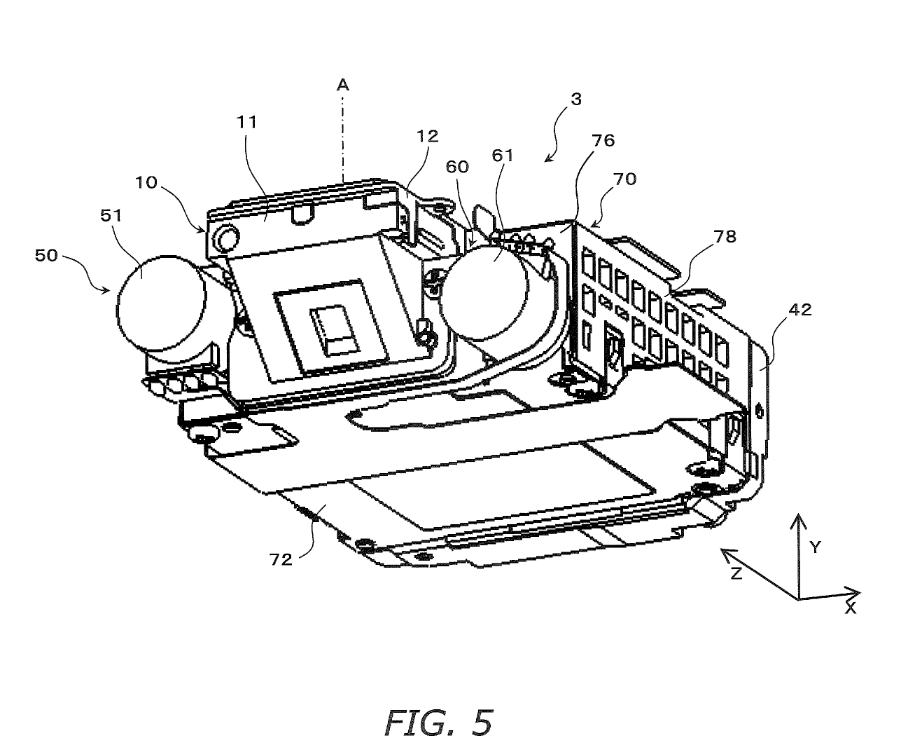

FIG. 5 is an oblique view of a lens barrel from directions in which its rear face, top face, and left face can be seen;

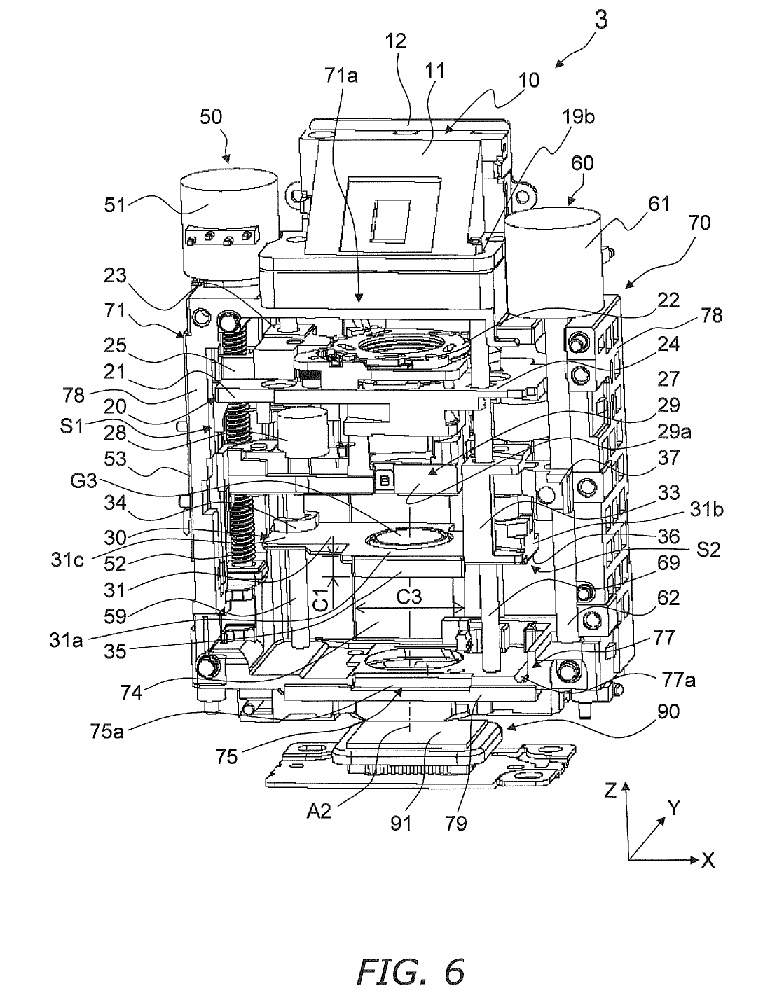

FIG. 6 is an oblique view of the lens barrel as seen from the rear face side (in a state in which a rear plate and a second frame have been removed);

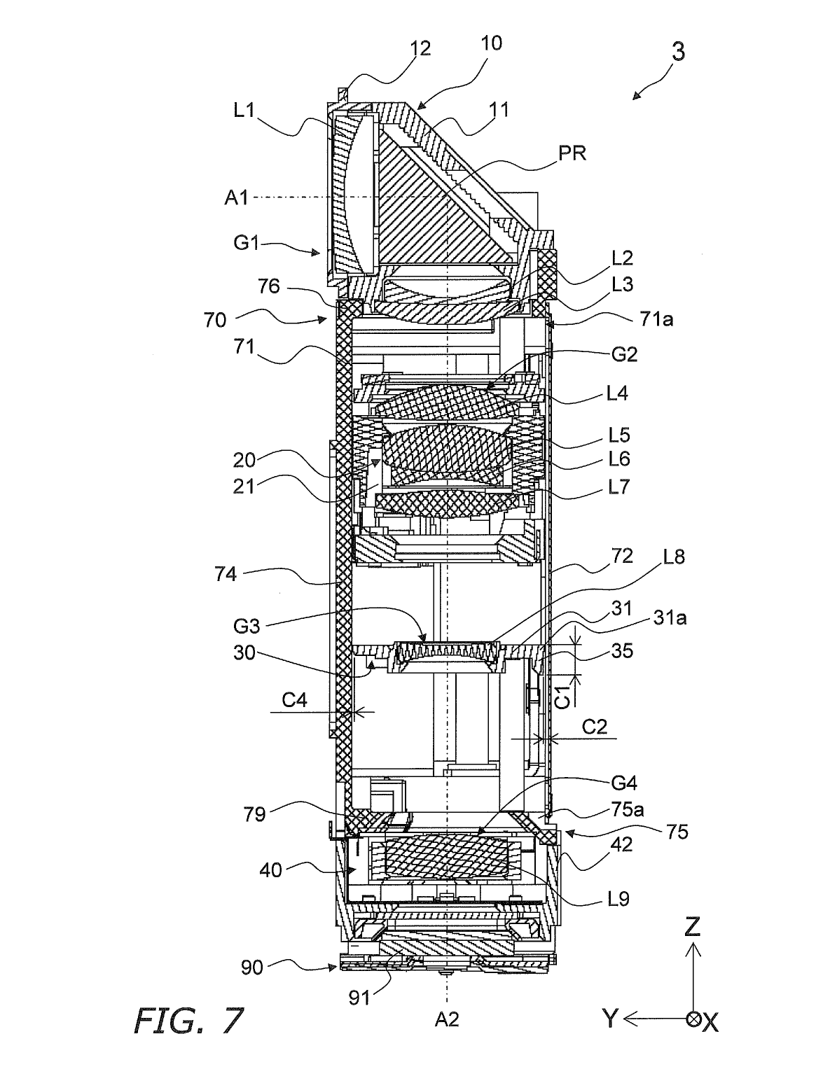

FIG. 7 is a cross section of the lens barrel along a plane including the first optical axis and the second optical axis;

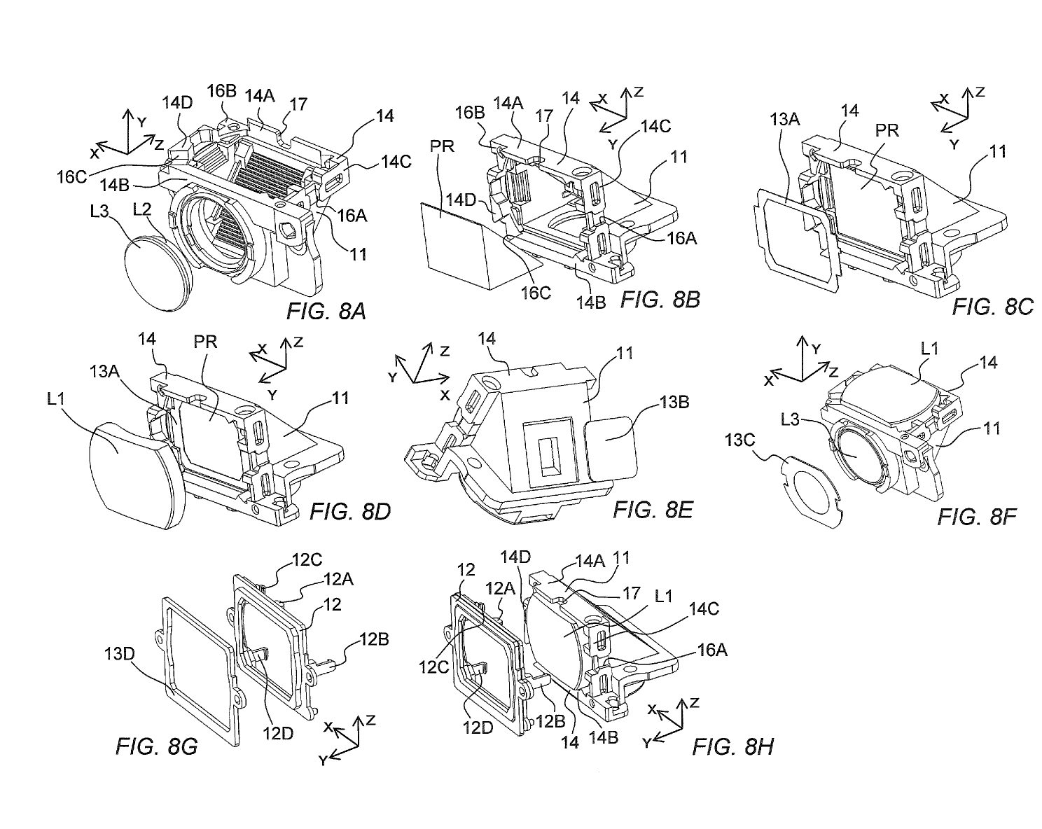

FIGS. 8A to 8H are diagrams illustrating the assembly of a first support frame and the assembly of a first lens group;

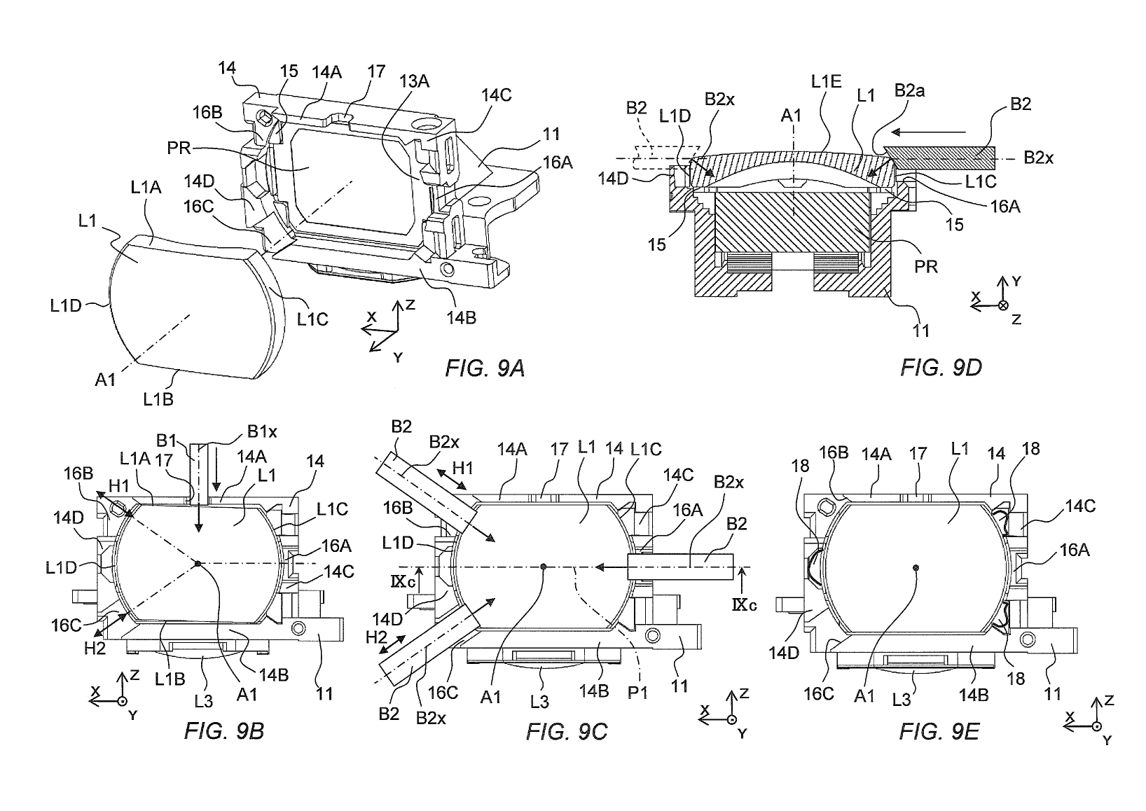

FIGS. 9A to 9E are diagrams illustrating alignment;

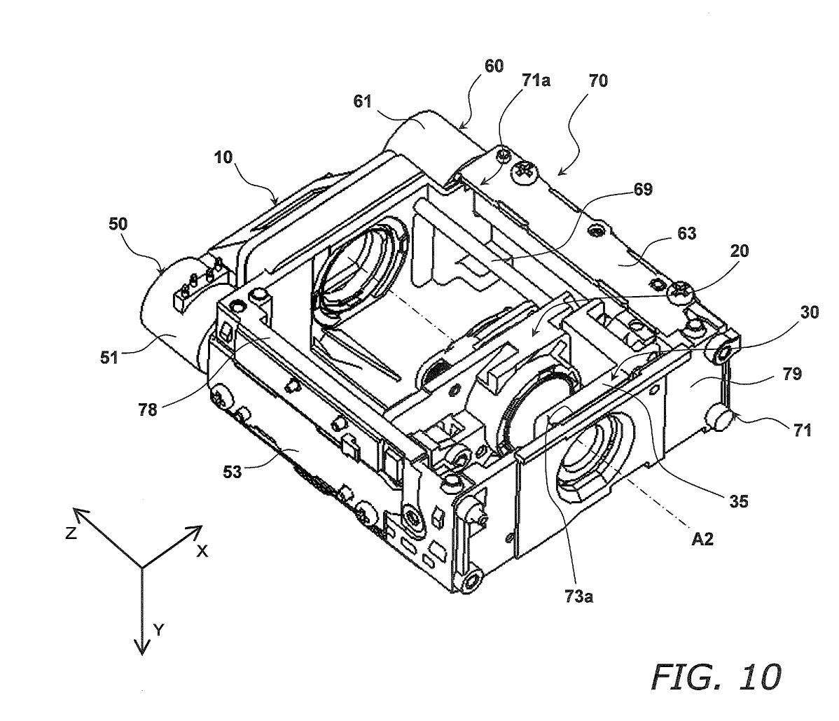

FIG. 10 is an oblique view illustrating the attachment position of a first drive unit and second drive unit;

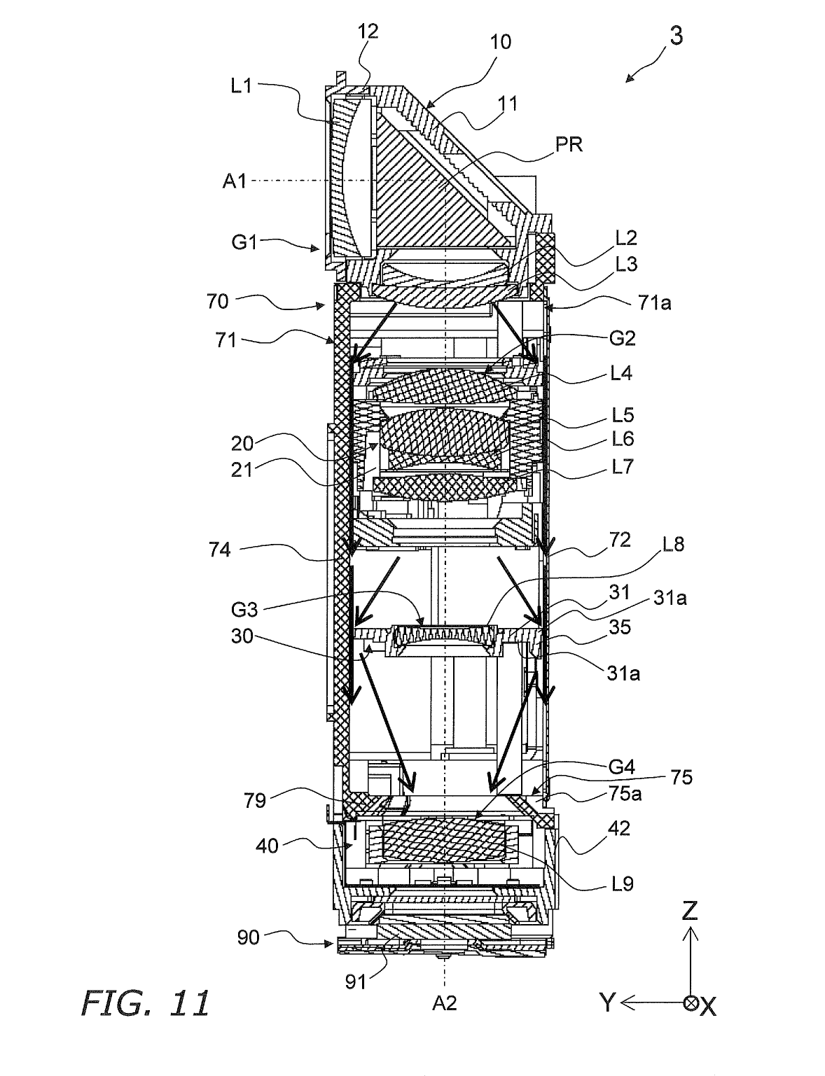

FIG. 11 is a diagram of the path of unnecessary light;

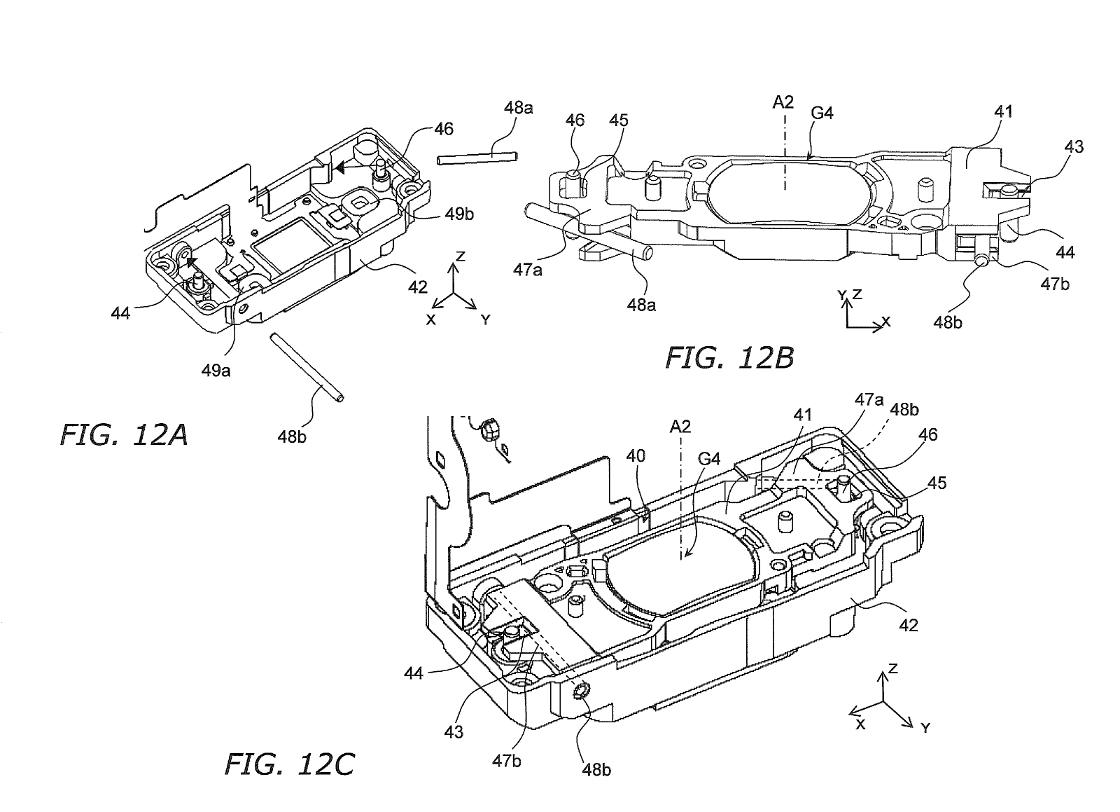

FIGS. 12A to 12C are diagrams illustrating a lens drive device;

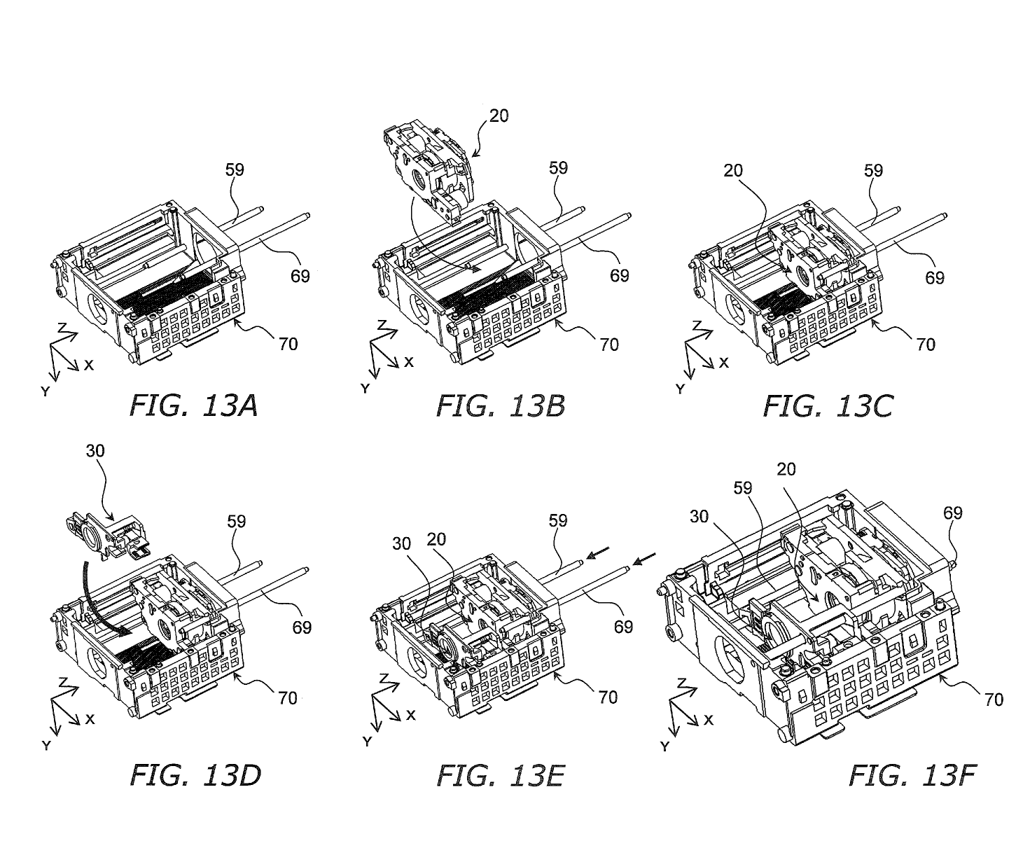

FIGS. 13A to 13F are diagrams illustrating the steps of installing a second support frame and a third support frame in a main body frame;

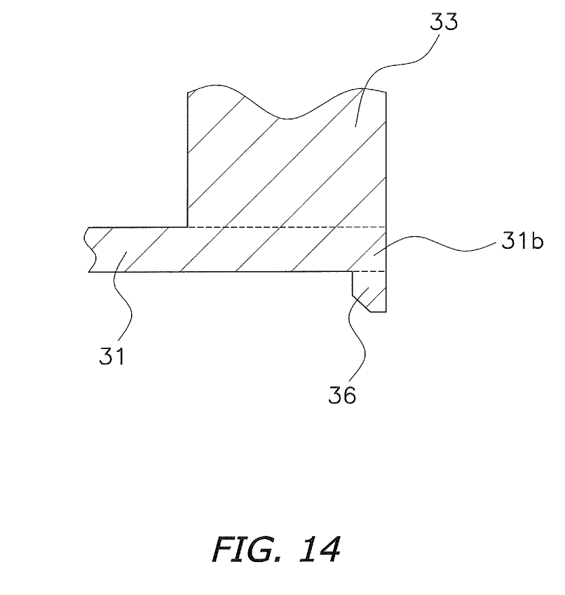

FIG. 14 is a cross section of the area around the second protrusion (a cross section perpendicular to the Y-axis direction);

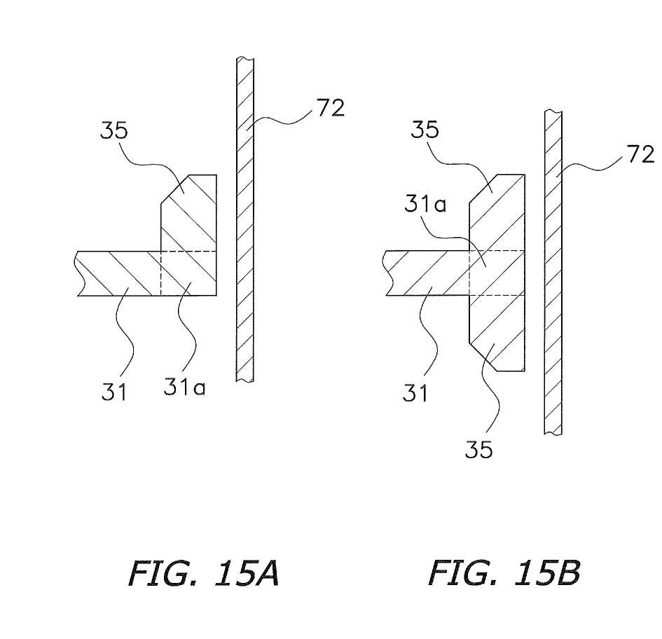

FIGS. 15A and 15B are cross sections of the area around the first protrusion (cross sections perpendicular to the X-axis direction); and

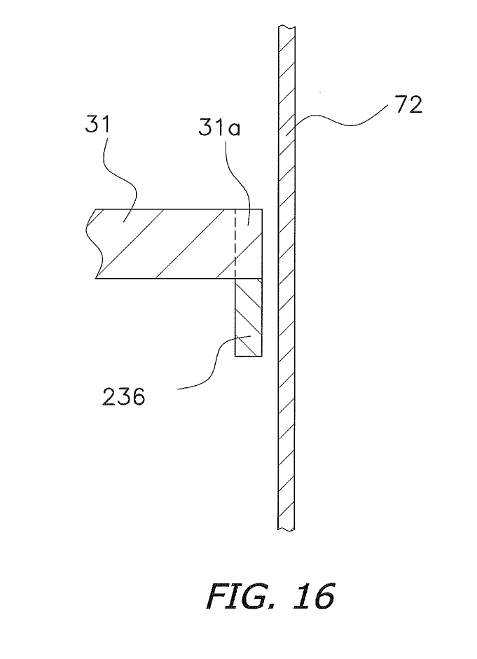

FIG. 16 is a cross section of the area around a light blocking sheet (a cross section perpendicular to the X-axis direction).

### DETAILED DESCRIPTION

Selected embodiments of the digital camera will now be explained with reference to the drawings. It will be apparent to those skilled in the art from this disclosure that the following descriptions of the embodiments of the digital camera are provided for illustration only and not for the purpose of limiting the invention as defined by the appended claims and their equivalents.

Summary of Digital Camera

Referring initially to FIGS. 1 and 2, simplified oblique views of the digital camera 1 are shown.

The digital camera 1 is a camera used for acquiring an image of a subject and employs a bending optical system in order to increase zoom magnification and reduce the overall size.

In the following description, the six sides of the digital camera 1 are defined as follows:

The side that faces the subject when an image is captured with the digital camera 1 is called the front face of a camera body 2, and the opposite side is called the rear face. When an image is captured such that the top and bottom of the subject in the vertical direction coincide with the short-side top and bottom of a rectangular image (generally with an aspect ratio (the ratio of the long side to the short side) of 3:2, 4:3, 16:9, etc.) captured by the digital camera 1, the side of the camera facing upward (vertically) is called the top face, and the opposite side is called the bottom face. Further, when an image is captured such that the top and bottom of the subject in the vertical direction coincide with the short-side top and bottom of a rectangular image captured by the digital camera 1, the side of the camera that is to the left when viewed from the subject side is called the left face, and the opposite side is called the right face. The above definitions are not intended to limit the orientation in which the digital camera 1 is used.

According to the above definitions, FIG. 1 is an oblique view of the front, top, and right faces.

In addition to the six sides of the digital camera 1, the six sides of the various constituent members disposed in the digital camera 1 are similarly defined. That is, the above definitions apply to the six sides of the various constituent members when they have been disposed in the digital camera 1.

Also, as shown in FIG. 1, there is defined a three-dimensional coordinate system having a Y-axis that is perpendicular to the front face of the camera body 2. With this definition, the direction from the rear face side toward the front face side is the Y-axis direction positive side, the direction from the right face side toward the left face side is the X-axis direction positive side, and the direction from the bottom face side toward the top face side is the Z-axis direction positive side.

This XYZ coordinate system will be referred to in the following description of the drawings. That is, the X-axis direction positive side, the Y-axis direction positive side, and the Z-axis direction positive side in the drawings indicate the same respective directions.

Overall Configuration of Digital Camera

As shown in FIGS. 1 and 2, the digital camera 1 typically comprises a camera body 2 that houses the various units, a lens barrel 3 that forms an optical image of a subject, and an imaging unit 90 (see FIG. 3A). The imaging unit 90 has an imaging element 91 (see FIG. 7) for converting an optical image into an image signal, and examples of the imaging element 91 include a CCD (charge coupled device) or CMOS (complementary metal-oxide semiconductor) sensor.

A release button 4, a control dial 5, a power switch 6, and a zoom adjustment lever 7 are provided to the top face of the camera body 2 so that the user can capture images and perform other such operations. The release button 4 is a button for inputting the exposure timing. The control dial 5 is a dial for making various settings related to image capture. The power switch 6 is used to switch the digital camera 1 on and off. The zoom adjustment lever 7 is used to adjust the zoom magnification, and can rotate over a specific angle range around the release button 4. A liquid crystal monitor 8 that displays images acquired by the imaging element 91 is provided to the rear face of the camera body 2.

Configuration of Lens Barrel

As shown in FIGS. 4 to 7, the lens barrel 3 (an example of a lens barrel structure) has an imaging optical system O, a lens case 70 (an example of a lens case structure), a first support frame 10, a second support frame 20, a third support frame 30 (an example of a movable support frame), a first drive unit 50, a second drive unit 60, an aperture unit 22, a shutter unit 29, and a lens drive device 40.

(1) Imaging Optical System

First, the imaging optical system O that forms an optical image of a subject will be described. As shown in FIG. 3A, the imaging optical system O has a first lens group G1, a second lens group G2, a third lens group G3 (an example of a movable lens group), and a fourth lens group G4.

The first lens group G1 is a lens group having negative refractive power overall and takes in light from the subject along a first optical axis A1. More specifically, the first lens group G1 is supported by the first support frame 10 and has a first lens L1 (an example of a first lens element), a prism PR (an example of a bending optical element), a second lens L2, and a third lens L3 (an example of a second lens element). However, it should be understood from the drawings and the disclosure contained herein that the first lens group G1 may have the prism PR and at least one of the first lens L1 and the second lens L2. For example, the first lens group G1 may have either the first lens L1 and the prism PR or the prism PR and the second lens L2. Alternatively the first lens group G1 may have, for example, the prism PR and the second lens L2.

The first lens group G1 includes the first optical axis A1 and the second optical axis A2. In other words, the first lens L1 has the first optical axis A1, and the second lens L2 and the third lens L3 have the second optical axis A2 which is substantially perpendicular to and intersects with the first optical axis A1. The prism PR is an internal reflection prism, for example, and guides light incident along the first optical axis A1 in the Z-axis direction. More specifically, the prism PR has a reflecting face PR1 that reflects light incident along the first optical axis A1 in the Z-axis direction. With the digital camera 1, the first optical axis A1 is parallel to the Y-axis, and the second optical axis A2 is parallel to the Z-axis. The Y-axis direction is an example of a second direction parallel to the first optical axis A1. The Z-axis direction is an example of a first direction parallel to the second optical axis A2. The X-axis direction is an example of a third direction perpendicular to the first and second directions.

The second lens group G2 is a lens group having an overall positive refractive power, and takes in light that has been bent by the first lens group G1. More specifically, the second lens group G2 is supported by the second support frame 20, and has a fourth lens L4, a fifth lens L5, a sixth lens L6, and a seventh lens L7. The fourth to seventh lenses L4 to L7 are supported by the second support frame 20 such that the optical axes of the fourth to seventh lenses L4 to L7 will substantially coincide with the second optical axis A2. The second support frame 20 is provided to be movable in the Z-axis direction with respect to the main body frame 71, and the fourth to seventh lenses L4 to L7 move integrally in the Z-axis direction from the wide angle end toward the telephoto end. Accordingly, the second lens group G2 can function as a zoom group that changes the magnification of the imaging optical system O. The zoom group operable to change a focal length of the imaging optical system O.

The third lens group G3 has an eighth lens L8 that takes in light that has passed through the second lens group G2 and has positive refractive power. The eighth lens L8 is supported by the third support frame 30 so that the optical axis of the eighth lens L8 will substantially coincide with the second optical axis A2. The third support frame 30 is provided to be movable in the Z-axis direction, which is parallel to the second optical axis A2, with respect to the main body frame 71, and the eighth lens L8 moves in the Z-axis direction from a closest object point toward an infinite object point. Accordingly, the eighth lens L8 can function as a focus lens.

The fourth lens group G4 has a ninth lens L9 that takes in light that has passed through the third lens group G3 and functions as an image blur correcting lens. The ninth lens L9 is supported by a lens drive device 40 (discussed below) to be movable within a plane perpendicular to the second optical axis A2. The optical axis of the fourth lens group G4 faces in substantially the same direction as the second optical axis A2. The fourth lens group G4 does not move in the Z-axis direction with respect to the lens case 70.

The aperture stop of this imaging optical system O is always located on the first lens group G1 side of the second lens group G2. The position of the aperture stop moves along with the second lens group G2 from the wide angle end toward the telephoto end. An aperture unit 22 (light quantity adjusting unit) is disposed at the position of the aperture stop. The aperture unit 22 is fixed to the second support frame 20, and moves along with the second lens group G2 in the Z-axis direction.

The arrows shown in FIG. 3B shows the movement in the Z-axis direction of the various lens groups in zooming from the wide angle end to the telephoto end. In zooming, the first lens group G1 and the fourth lens group G4 do not move in the Z-axis direction. The second lens group G2 moves greatly from the Z-axis direction negative side (lower side) to the Z-axis direction positive side (upper side) in zooming from the wide angle end to the telephoto end. The third lens group G3 moves from the Z-axis direction negative side (lower side) to the Z-axis direction positive side (upper side) in zooming from the wide angle end to the telephoto end. The third lens group G3 also moves independently to the Z-axis direction positive side and negative side (up and down) in focus adjustment (focusing). As shown in FIG. 3B, the second lens group G2 is provided movably in the Z-axis direction within a first movement range M1. The third lens group G3 is provided movably in the Z-axis direction within a second movement range M2. Part of the first movement range M1 overlaps with a part of the second movement range M2.

The imaging optical system O does not move in the Y-axis direction during zooming. Therefore, the size of the imaging optical system O in the Y-axis direction can be reduced. Furthermore, some or all of the lenses L2 to L9 that make up the fourth lens group G4 are in a shape that is not circular as seen in the Z-axis direction, but instead a circle that has been cut at the front (Y-axis direction positive side) and rear (Y-axis direction negative side). Consequently, the size of the imaging optical system O in the Y-axis direction can be reduced, and the thickness of the camera body 2 (the dimension in the Y-axis direction) can be reduced. In this embodiment, the above-mentioned circle is cut out only for the ninth lens L9, which have relatively large lens diameters.

Just as with the ninth lens L9, the first lens L1 also has a shape that is cut out on the upper side (Z-axis direction positive side) and lower side (Z-axis direction negative side) when viewed in the Y-axis direction. Specifically, silhouettes of the first lens L1 and the ninth lens L9 have a shape that is closed off by a pair of arcs and two straight lines when seen in the optical axis direction. The lenses L1 to L9 may be circular, arc-shaped, or have a shape that is closed off by at least one straight line, when viewed in the optical axis direction. In FIG. 3, for the sake of convenience in drawing, the first lens L1 and the ninth lens L9 are shown as circles as seen in the optical axis direction.

(2) Lens Case

As shown in FIGS. 4 to 7, the lens case 70 has a main body frame 71 and a rear plate 72 (an example of a cover member or a second plate). The main body frame 71 has a front plate 74 (an example of a first plate) disposed on the Y-axis direction positive side of the second optical axis A2, a top plate 76, a bottom plate 79, and a pair of side plates 78.

The top plate 76 is disposed on the Z-axis direction positive side of the front plate 74, and protrudes from the front plate 74 to the Y-axis direction negative side. The bottom plate 79 is disposed on the Z-axis direction negative side of the front plate 74, and protrudes from the front plate 74 to the Y-axis direction negative side. The pair of side plates 78 are disposed on the X-axis positive and negative sides of the front plate 74, and protrude from the front plate 74 to the Y-axis direction negative side.

The top plate 76, the bottom plate 79, and the pair of side plates 78 form an opening 71a that opens on the Y-axis direction negative side. The opening 71a is disposed on the Y-axis direction negative side (rear face side) of the main body frame 71. The rear plate 72 covers the opening 71a and is removably mounted to the main body frame 71. The rear plate 72 is thinner than the front plate 74. Since the rear plate 72 is thinner than the front plate 74, the rear plate 72 is more susceptible to deformation than the front plate 74.

The bottom plate 79 has a first housing portion 75 (an example of a first groove portion or a first recess portion) and a second housing portion 77 (an example of a second groove portion or a second recess portion). As shown in FIGS. 6 and 7, the first housing portion 75 is disposed at a position corresponding to a first protruding part 35 (discussed below) in the Z-axis direction, and is provided to be able to house the first protruding part 35. The first housing portion 75 has a first groove 75a (an example of a first aperture) provided to be able to house the first protruding part 35. When the third support frame 30 moves close to the bottom plate 79, the first protruding part 35 is housed in the first groove 75a.

Also, as shown in FIG. 6, the second housing portion 77 is disposed at a position corresponding to a second protruding part 36 (discussed below) in the Z-axis direction, and is provided to be able to house the second protruding part 36. The second housing portion 77 has a second groove 77a (an example of a second aperture) provided to be able to house the second protruding part 36. When the third support frame 30 moves close to the bottom plate 79, the second protruding part 36 is housed in the second groove 77a.

Some of the lens groups of the imaging optical system O (more precisely, the lens groups other than the first lens group G1) are housed in the lens case 70. Only the first lens group G1 is disposed outside of the lens case 70. Only the first lens L1 of the first lens group G1 is exposed to the outside (see FIG. 1). The imaging unit 90 is housed in a master flange 42. Light incident from the first lens L1 is guided to the imaging face of the imaging unit 90. The lens case 70 is designed so that light does not fall on the imaging face of the imaging unit 90 from anywhere but the first lens L1.

The lens case 70 is also designed to be smaller in the Y-axis direction in order to take advantage of the fact that the size of the imaging optical system O in the Y-axis direction can be reduced. The lens case 70 is thinner (the dimension in the Y-axis direction) than it is wide (the dimension in the X-axis direction). The lens case 70 is a substantially rectangular container that extends narrowly in the X-axis direction and Z-axis direction. Therefore, the surface area of the front plate 74 is much larger than the surface area of the top plate 76 and the surface area of the bottom plate 79.

(3) First Support Frame

The first support frame 10 supports the first lens group G1. The imaging optical system O is supported by the various support frames. More specifically, the first lens group G1 is fixed by adhesive bonding, for example, to the first support frame 10. The first support frame 10 is fixed to the end of the main body frame 71 on the Z-axis direction positive side. The first support frame 10 mainly has a first support frame main body 11, a cover cap 12, a light blocking sheet 13A, and a cushion 13D. As shown in FIG. 7, the first lens L1, prism PR, second lens L2, and third lens L3 of the first lens group G1 are fixed to the first support frame main body 11.

The light blocking sheet 13A prevents light from coming in from around the incident plane of the prism PR. The light blocking sheet 13A is fitted into an opening in the first support frame main body 11, and is sandwiched between the prism PR and the first lens L1. The cover cap 12 is fixed on the Y-axis direction positive side of the first support frame main body 11. The cover cap 12 covers the area around the first lens L1 when seen from the front (subject side). The cushion 13D is fixed on the Y-axis direction positive side of the cover cap 12.

The assembly of the first support frame 10 and the first lens group G1 here will be described through reference to FIGS. 8A to 8H. The second lens L2 and the third lens L3 are joined to each other. As shown in FIG. 8A, the second lens L2 and the third lens L3 are fixed in an opening on the lower face of the first support frame main body 11. For example, the third lens L3 is fixed by thermal caulking to the first support frame main body 11. As shown in FIG. 8B, the prism PR is bonded by adhesive to the first support frame main body 11. As shown in FIG. 8C, the light blocking sheet 13A is disposed on the front face of the prism PR. As shown in FIG. 8D, the first lens L1 is fixed to the front face of the first support frame main body 11. The position of the first lens L1 with respect to the first support frame main body 11 is adjusted to satisfy specific optical characteristics for the first lens group G1 as a whole. This adjustment will be called “alignment” from here on. After alignment, the first lens L1 is fixed by adhesive to the first support frame main body 11. The details of the alignment will be discussed below. As shown in FIG. 8E, a light blocking sheet 13B is fixed to the first support frame main body 11 to cover the hole on the rear face of the first support frame main body 11. As shown in FIG. 8F, a sheet 13C is fixed to the lower face of the first support frame main body 11 to cover the area around the third lens L3. As shown in FIG. 8G, the cushion 13D is fixed to the front face of the cover cap 12. As shown in FIG. 8H, the cover cap 12 is fixed to the front face of the first support frame main body 11. The above completes the first support frame 10 on which the first lens group G1 is supported.

Next, “alignment” will be described through reference to FIGS. 9A to 9E.

As shown in FIG. 9A, the first lens L1 has a shape in which a circular lens is cut off at the top and bottom when viewed in a direction parallel to the first optical axis A1. In other words, the first lens L1 has a shape that is closed off by two arcs and two lines (more specifically, straight lines) when viewed in a direction parallel to the first optical axis A1.

The first lens L1 has a convex face L1E, a first side face L1A, a second side face L1B, a third side face L1C, and a fourth side face L1D. The convex face LIE is the face on which light from the subject side is incident. The first side face L1A is flat. The second side face L1B is a flat face disposed on the opposite side from the first side face L1A, with the first optical axis A1 sandwiched in between. In this embodiment, the second side face L1B is disposed parallel to the first side face L1A, and has the same shape as the first side face L1A. The third side face L1C is disposed between the first side face L1A and the second side face L1B, and forms an arc whose center is the first optical axis A1. The fourth side face L1D is disposed on the opposite side form the third side face L1C, with the first optical axis A1 sandwiched in between, and forms an arc whose center is the first optical axis A1. In this embodiment, the fourth side face L1D has the same shape as the third side face L1C.

Meanwhile, as shown in FIG. 9A, the first support frame main body 11 has four contact portions 15 and a wall portion 14. The contact portions 15 are portions that perform positioning of the first lens L1 in the Y-axis direction, and come into contact with the first lens L1 when the first lens L1 is fixed.

The wall portion 14 protrudes forward to surround the area around the first lens L1. The position of the wall portion 14 in the Y-axis direction substantially coincides with the position of the side face of the first lens L1 in the Y-axis direction. More specifically, the wall portion 14 has a first wall portion 14A, a second wall portion 14B, a third wall portion 14C, and a fourth wall portion 14D. The first wall portion 14A is disposed to be opposite to the first side face L1A in the Z-axis direction. The second wall portion 14B is disposed to be opposite to the second side face L1B in the Z-axis direction, and comes into contact with the second side face L1B. The third wall portion 14C is disposed to be opposite to the third side face L1C. The fourth wall portion 14D is disposed to be opposite to the fourth side face L1D.

The first wall portion 14A has a first cut-out 17 that passes through in the Z-axis direction (an example of a first passing direction). The third wall portion 14C has a second cut-out 16A that passes through in the X-axis direction (an example of a second passing direction). The fourth wall portion 14D has a third cut-out 16B that passes through in a H1 direction (an example of a third passing direction, see FIG. 9B) perpendicular to the Y-axis direction, and a fourth cut-out 16C that passes through in a H2 direction (an example of a fourth passing direction, see FIG. 9B) perpendicular to the Y-axis direction.

The second cut-out 16A passes through in the X-axis direction, and passes through toward the first optical axis A1 so that second adjusting rods B2 (discussed below) face the first optical axis A1. Similarly, the third and fourth cut-outs 16B and 16C pass through toward the first optical axis A1 so that the second adjusting rods B2 face the first optical axis A1.

Also, as shown in FIG. 9C, the second cut-out 16A is disposed at a position that is opposite the center of the third side face L1C, and is disposed at a position overlapping a plane P1 that is parallel to the X-axis direction and includes the first optical axis A1. The plane P1 can also be called a plane that is perpendicular to the Z-axis direction and includes the first optical axis A1. Meanwhile, the third and fourth cut-outs 16B and 16C are disposed on both sides with this plane P1 sandwiched in between. In other words, the third and fourth cut-outs 16B and 16C are disposed at positions that are shifted from positions on the opposite side from the second cut-out 16A with the first optical axis A1 sandwiched in between. Also, the first wall portion 14A is disposed on the opposite side from the third lens L3 with respect to the plane P1, and the second wall portion 14B is disposed on the same side as the third lens L3 with respect to the plane P1.

As shown in FIG. 9B, in a state in which the first lens L1 is in contact with the contact portions 15, a gap is ensured between the wall portion 14 and the side face of the first lens L1. Therefore, the first lens L1 is movable in a direction perpendicular to the first optical axis A1 within a range of the interior of the wall portion 14.

However, in order to make the first support frame 10 smaller, the wall portion 14 has a shape, as seen from the front, that follows the side face of the first lens L1. Therefore, as shown in FIG. 9B, in a state in which the first side face L1A is sloped with respect to the first wall portion 14A, the gap in the Z-axis direction between the first lens L1 and the wall portion 14 is smaller. In this state, the first lens L1 cannot move parallel to the Z-axis direction with respect to the first support frame main body 11. In other words, there are situations in which the first lens L1 cannot be moved in a direction substantially perpendicular to the first side face L1A and the second side face L1B with respect to the first support frame main body 11.

In view of this, the orientation of the first lens L1 is adjusted so that the first side face L1A is parallel to the first wall portion 14A. More specifically, as shown in FIG. 9B, in a state in which the first lens L1 is in contact with the contact portions 15, a first adjusting rod B1 is inserted into the first cut-out 17 provided to the first wall portion 14A. Here, the first adjusting rod B1 presses the first side face L1A of the first lens L1 in a direction perpendicular to the first optical axis A1 (more precisely, to the Z-axis direction negative side). For example, when viewed in the Y-axis direction, the center axis B1x of the first adjusting rod B1 faces the first optical axis A1. Consequently, the second side face L1B of the first lens L1 comes into contact with the second wall portion 14B, and the orientation of the first lens L1 around the first optical axis A1 is determined. If the second side face L1B is in contact with the second wall portion 14B, it is possible for the first lens L1 to move in the Z-axis direction with respect to the first support frame main body 11, and the position of the first lens L1 in the Z-axis direction can be adjusted.

Next, as shown in FIG. 9C, the second adjusting rods B2 are inserted into the second cut-out 16A, the third cut-out 16B, and fourth cut-out 16C. As shown in FIG. 9D, the distal end of the second adjusting rods B2 are not perpendicular with respect to their center axis B2x, and instead have a shape that is cut off at an angle. That is, the second adjusting rods B2 have a taper face B2a formed at their distal end. In pressing the second adjusting rods B2 against the first lens L1, the positions of the second adjusting rods B2 are determined so that the taper faces B2a will come into contact with the edges on the front side of the third side face L1C and the fourth side face L1D (Y-axis direction positive side) (the boundary between the convex face LIE and the third side face L1C, and the boundary between the convex face LIE and the fourth side face L1D). As a result, the first lens L1 is subjected to a force from the second adjusting rods B2 in a direction parallel to the center axis B2x, as well as to a force in a direction parallel to the first optical axis A1 (more precisely, the Y-axis direction negative side). Consequently, the position of the first lens L1 can be adjusted by the second adjusting rods B2 in a state in which the first lens L1 is pressed against the four contact portions 15.

When the second adjusting rods B2 are moved in a direction perpendicular to the first optical axis A1 in a state of being sandwiched by three second adjusting rods B2, the first lens L1 can be moved within a plane perpendicular the first optical axis A1 with respect to the first support frame main body 11. Here, since enough room for parallel movement is ensured by the step illustrated in FIG. 9B and discussed above, there is no need to rotate the first lens L1 around the first optical axis A1, and alignment of the first lens L1 can be accomplished merely by moving the second adjusting rods B2 in parallel in the X-axis direction. Therefore, the alignment process can be simplified. The position of the first lens L1 is adjusted to a position that satisfies specific optical characteristics for the first lens group G1 as a whole, and this position is held by the second adjusting rods B2.

Finally, as shown in FIG. 9E, the area around the first lens L1 is coated with an adhesive 18, and the first lens L1 is fixed to the first support frame main body 11 by this adhesive. The adhesive 18 is an ultraviolet curing resin, for example.

As shown in FIG. 8H, after alignment, the cover cap 12 is fixed to the first support frame main body 11. The first cut-out 17, the second cut-out 16A, the third cut-out 16B, and the fourth cut-out 16C are covered by the cover cap 12. More specifically, the cover cap 12 has blockers 12A to 12D that cover the first cut-out 17, the second cut-out 16A, the third cut-out 16B, and the fourth cut-out 16C. The blockers 12A to 12D have shapes that are complementary with those of the first cut-out 17, the second cut-out 16A, the third cut-out 16B, and the fourth cut-out 16C, respectively, and are fitted into the first cut-out 17, the second cut-out 16A, and the third cut-out 16B, and the fourth cut-out 16C. This prevents light from coming in from the first cut-out 17, the second cut-out 16A, the third cut-out 16B, and the fourth cut-out 16C.

(4) Second Support Frame

As shown in FIGS. 6 and 7, the second support frame 20 supports the second lens group G2. The second lens group G2 is fixed by adhesive bonding, for example, to the second support frame 20. A first guide shaft 59 and a second guide shaft 69 are fixed to the main body frame 71. The second support frame 20 is supported movably along the second optical axis A2 by the first guide shaft 59 and the second guide shaft 69.

More specifically, the second support frame 20 has a second support frame main body 21 to which the second lens group G2 is fixed, a first guide portion 23 that slides with the first guide shaft 59, a second guide portion 24 that slides with the second guide shaft 69, and a first drive member 25 that receives the drive force generated by the first drive unit 50. The second support frame 20, the first guide shaft 59, and the second guide shaft 69 constitute a first support mechanism S1 that movably supports the second lens group G2. The second support frame 20 is mainly guided in the Y-axis direction by the first guide shaft 59. The second guide shaft 69 prevents the second support frame 20 from rotating around the first guide shaft 59.

(5) First Drive Unit

As shown in FIGS. 6 and 10, the first drive unit drives the second support frame 20 in the Z-axis direction. More specifically, the first drive unit 50 has a first drive motor 51, a first lead screw 52 that is rotationally driven by the first drive motor 51, and a first frame 53 that supports the first drive motor 51 and the first lead screw 52.

The first frame 53 is fixed to the main body frame 71. The first drive member 25 meshes with the first lead screw 52. The first drive member 25 is supported by the second support frame main body 21 rotatably and to move integrally in the axial direction. Because of this constitution, when the first lead screw 52 rotates, the second support frame 20 moves along the second optical axis A2.

(6) Aperture Unit and Shutter Unit

The aperture unit 22 and the shutter unit 29 are fixed to the second support frame 20. The aperture unit 22 is fixed on the first lens group G1 side of the second support frame 20, and the shutter unit 29 is fixed on the imaging unit 90 side of the second support frame 20 (the opposite side from the first lens group G1). The aperture unit 22 and the shutter unit 29 are driven in the Z-axis direction by the first drive unit 50, integrally with the second support frame 20.

The shutter unit 29 has a shutter mechanism 29a provided to open up and block off the optical path along the second optical axis A2, and a shutter drive motor 27 that drives the shutter mechanism 29a. The shutter drive motor 27 is disposed more to the first lens group G1 side than the shutter mechanism 29a in the Z-axis direction.

The shutter unit 29 is further provided with a dimmer filter (not shown) provided so that it can be inserted into or retracted from the optical path along the second optical axis A2, and a filter drive motor 28 that drives the dimmer filter. The filter drive motor 28 is disposed more to the first lens group G1 side than the dimmer filter in the Z-axis direction.

(7) Third Support Frame

As shown in FIGS. 6 and 7, the third support frame 30 supports the third lens group G3. The third lens group G3 is fixed to the third support frame 30 by caulking, for example. The third support frame 30 is supported by the first guide shaft 59 and the second guide shaft 69 to be movable along the second optical axis A2. More specifically, the third support frame 30 has a third support frame main body 31 to which the third lens group G3 is fixed, a third guide portion 33 (an example of a sliding part) that slides with the second guide shaft 69, a fourth guide portion 34 that slides with the first guide shaft 59, a second drive member 37 that receives drive force generated by the second drive unit 60, the first protruding part 35, and the second protruding part 36. In this embodiment, the third support frame 30 is formed integrally.

The third support frame main body 31 is a substantially plate-shaped portion, and supports the third lens group G3. The third support frame main body 31 has a first end part 31a disposed at an end in the Y-axis direction (a second direction parallel to the first optical axis A1), and a second end part 31b and third end part 31c disposed at opposing ends in the X-axis direction. The third guide portion 33 is provided to the second end part 31b, and extends from the third support frame main body 31 to the Z-axis direction positive side. The second guide shaft 69 is inserted into the third guide portion 33. The third end part 31c is disposed on the opposite side from the second end part 31b.

The first protruding part 35 is provided to the first end part 31a, and protrudes from the third support frame main body 31 in the Z-axis direction (more precisely, to the Z-axis direction negative side, which is the opposite side from the first lens group G1). As shown in FIG. 7, the first protruding part 35 is disposed adjacent to the lens case 70 in the Y-axis direction. C1 is the combined length of the first end part 31a and the first protruding part 35 in the Z-axis direction. C2 is the dimension of the space in the Y-axis direction formed between the first end part 31a and the lens case 70. The dimension C1 is larger than the dimension C2. Also, as shown in FIG. 6, the first protruding part 35 extends in the X-axis direction. C3 is the longitudinal distance of the first protruding part 35 along the X-axis direction. The dimension C3 is larger than the dimension C1 of the first protruding part 35 in the Z-axis direction. As is clear from FIGS. 6 and 7, the first protruding part 35 overlaps the second optical axis A2 when viewed in the Y-axis direction. Furthermore, the dimension C3 of the first protruding part 35 in the X-axis direction is set to be larger than the outside diameter of the eighth lens L8.

As shown in FIGS. 6 and 14, the second protruding part 36 is provided to the second end part 31b, and protrudes from the third support frame main body 31 in the Z-axis direction (more precisely, to the Z-axis direction negative side, which is the opposite side from the first lens group G1). The dimension of the second protruding part 36 in the Y-axis direction is substantially the same as the dimension of the second end part 31b in the Y-axis direction. The dimension of the second protruding part 36 in the Z-axis direction is smaller than the dimension of the first protruding part 35 in the Z-axis direction.

The third support frame 30, the first guide shaft 59, and the second guide shaft 69 constitute a second support mechanism S2 that movably supports the third lens group G3. The third support frame 30 is mainly guided by the second guide shaft 69. The first guide shaft 59 prevents the third support frame 30 from rotating around the second guide shaft 69.

How the light passes through the lens case 70 will now be described. In addition to the path of light passing through the second lens group G2 and the third lens group G3 in between the first lens group G1 and the fourth lens group G4, there is also the path of light that escapes between the second support frame 20 and the main body frame 71, between the third support frame 30 and the main body frame 71, between the second support frame 20 and the rear plate 72, or between the third support frame 30 and the rear plate 72. Light that escapes between the second support frame 20 and the main body frame 71, between the third support frame 30 and the main body frame 71, between the second support frame 20 and the rear plate 72, or between the third support frame 30 and the rear plate 72 is called unnecessary light. The arrows shown in FIG. 11 are the main paths of unnecessary light. As shown in FIG. 11, unnecessary light does not pass through the imaging optical system O, and instead reaches the imaging unit 90 through a gap between a fixed member (the lens case 70) and movable members (the second support frame 20 and the third support frame 30). When unnecessary light is incident on the imaging element 91, it produces ghosting and flare, so it is preferable to suppress the incidence of unnecessary light.

In view of this, one way to suppress the incidence of unnecessary light is to reduce the gap formed between the fixed members, such as the main body frame 71 and the rear plate 72, and the moving members, such as the second support frame 20 and the third support frame 30.

However, a certain amount of gap must be provided for the moving members to be movable smoothly. Nor can all the gaps be reduced, and there are gaps that are difficult to reduce due to dimensional accuracy. In this embodiment, due to dimensional accuracy, the gap between the rear plate 72 and the second support frame 20 is larger than the gap between the main body frame 71 and the second support frame 20. Similarly, the gap between the rear plate 72 and the third support frame 30 is larger than the gap between the main body frame 71 and the third support frame 30. For example, as shown in FIG. 7, the dimension C2 is larger than the dimension C4 between the front plate 74 and the third support frame 30. Therefore, the amount of light that passes between the rear plate 72 and the third support frame 30 is greater than the amount of light that passes between the front plate 74 and the third support frame 30.

The reason for this difference in gaps is that positioning accuracy is different on the front and rear face sides of the lens case 70. More specifically, the second support frame 20 and the third support frame 30 are positioned with respect to the main body frame 71 via the first guide shaft 59 or the second guide shaft 69. Since the first guide shaft 59 and the second guide shaft 69 are fixed to the main body frame 71, the second support frame 20 and the third support frame 30 can be accurately positioned with respect to the main body frame 71. Therefore, for example, the gap between the front plate 74 and the second support frame 20, and the gap between the front plate 74 and the third support frame 30 are easier to reduce.

On the other hand, since the rear plate 72 is fixed to the main body frame 71, the second support frame 20 is positioned with respect to the rear plate 72 by the main body frame 71 and the first guide shaft 59, and the third support frame 30 is positioned with respect to the rear plate 72 by the main body frame 71 and the second guide shaft 69. Accordingly, the positioning accuracy of the second support frame 20 and the third support frame 30 with respect to the rear plate 72 is lower than the positioning accuracy of the second support frame 20 and the third support frame 30 with respect to the main body frame 71. Therefore, it is difficult to reduce the size of the gap formed by the second support frame 20, or the gap formed between the rear plate 72 and the third support frame 30.

In view of this, in this embodiment, the third support frame 30 has the first protruding part 35 that protrudes in the Z-axis direction from the third support frame main body 31 on the rear face side Y-axis direction negative side). The first protruding part 35 is opposite the lens case 70 (more specifically, the rear plate 72) on the rear face side (Y-axis direction negative side) of the third support frame 30. Consequently, the dimension in the Z-axis direction of the gap formed between the third support frame 30 and the rear plate 72 is relatively large, and unnecessary light incident in this gap tends to be attenuated within the gap. To describe this in more detail, when unnecessary light is incident in the gap formed between the third support frame 30 and the rear plate 72, the unnecessary light is reflected back and forth between the third support frame 30 (the third support frame main body 31 and the first protruding part 35) and the rear plate 72, and almost all of the unnecessary light is attenuated within the gap. Therefore, providing the first protruding part 35 reduces how much unnecessary light is incident on the imaging element 91, and reduces the effect of this unnecessary light.

Also, in this embodiment, since the third lens group G3 that is supported by the third support frame 30 is composed of just a single lens (the eighth lens L8), the dimension of the third support frame 30 in the Z-axis direction (that is, the thickness of the third support frame 30) is relatively small. Thus providing the first protruding part 35 to the thin third support frame 30 allows unnecessary light to be effectively attenuated by the first protruding part 35.

Since the unnecessary light also passes through a gap on the front face side, the first protruding part 35 may be provided on just the front face side (Y-axis direction positive side) of the third support frame 30, or may be provided on both the front face side (Y-axis direction positive side) and rear face side (Y-axis direction negative side). When the above-mentioned dimensional accuracy is taken into account, it is preferable to provide the first protruding part 35 on at least the rear face side (Y-axis direction negative side) of the third support frame 30. The “rear face side” here is the opening 71a side of the main body frame 71, which is the rear plate 72 side.

Furthermore, in this embodiment, since the third support frame main body 31 has a substantially uniform thickness, the dimension of the third support frame 30 in the Z-axis direction at the end in the X-axis direction (the thickness of the third end part 31c) is smaller than the dimension in the Z-axis direction of the portion of the third support frame 30 where the first protruding part 35 is disposed (the combined dimension C1 of the first end part 31a and the first protruding part 35). When viewed in the Z-axis direction, the dimension of the third support frame 30 in the Y-axis direction is smaller than the dimension of the third support frame 30 in the X-axis direction. That is, the third support frame 30 extends narrowly in the X-axis direction along the shape of the lens case 70. Accordingly, the distance from the second optical axis A2 to the end of the third support frame 30 in the Y-axis direction (such as the first end part 31a shown in FIGS. 6 and 7) is shorter than the distance from the second optical axis A2 to the end of the third support frame 30 in the X-axis direction (such as the third end part 31c shown in FIG. 6). In other words, the angle formed in the Z-axis direction (second optical axis A2) by the line linking the second lens group G2 and the third end part 31c is greater than the angle formed in the Z-axis direction (second optical axis A2) by the line linking the second lens group G2 and the first end part 31a. In this case, of the light that passes through the second lens group G2, there is less light that reaches the third end part 31c than light that reaches the first end part 31a. Therefore, there will not be much problem with unnecessary light if the dimension of the third end part 31c in the Z-axis direction is made smaller than the dimension C1, for example.

The space on the lower side of the third support frame 30 can be utilized more effectively by making the thickness of the end part of the third support frame 30 in the X-axis direction (such as the thickness of the third end part 31c) less than the dimension C1. In this embodiment, when the third support frame 30 is closest to the bottom plate 79 of the main body frame 71 in the usage state, that is, when the third support frame 30 is located the farthest on the Z-axis direction negative side, the first groove 75a is formed in the main body frame 71 so that the first protruding part 35 will not interfere with the main body frame 71. In this embodiment, since the first groove 75a is a cut-out (or depression) formed on the opening 71a side of the main body frame 71, there is little decrease in the strength of the main body frame 71 (strength of the bottom plate 79). Also, the thickness (dimension in the Z-axis direction) of the bottom plate 79 at the portion opposite the third end part 31c in the Z-axis direction is made greater than the thickness of the first groove 75a (size in the Z-axis direction). Therefore, the effect of unnecessary light can be reduced while ensuring adequate strength of the lens case 70.

As in this embodiment, the second protruding part 36, which protrudes from the third support frame main body 31 in the Z-axis direction, may also be provided to the end part of the third support frame 30 in the X-axis direction. The dimension of the second protruding part 36 in the Z-axis direction may be the same as or larger than the dimension C1 of the first protruding part 35 in the Z-axis direction, but when the unnecessary light attenuation effect and interference with other members are taken into account, it is preferable for it to be smaller than the dimension of the first protruding part 35 in the Z-axis direction.

(8) Second Drive Unit

As shown in FIGS. 6 and 10, the second drive unit 60 drives the third support frame 30 in the Z-axis direction. More specifically, the second drive unit 60 has a second drive motor 61, a second lead screw 62 that is rotationally driven by the second drive motor 61, and a second frame 63 that supports the second drive motor 61 and the second lead screw 62. In FIG. 6, the rear plate 72 and the second frame 63 are not depicted, so that the interior of the lens case 70 is easier to see.

As shown in FIGS. 6 and 10, the second frame 63 is fixed on the opening 71a side of the main body frame 71, that is, on the rear face side. The second drive member 37 meshes with the second lead screw 62. Although the thread shape of the second lead screw 62 is not depicted in the drawings, it is the same as the thread shape of the first lead screw 52. The second drive member 37 is supported by the third support frame main body 31 rotatably and to move integrally in the axial direction. When the second lead screw 62 rotates, the third support frame 30 moves along the second optical axis A2.

The disposition of the second frame 63 will now be described in more specific terms. The second drive unit is inserted into the main body frame 71 from the opening 71a side of the main body frame 71, and the second lead screw 62 is disposed to be in a specific position. The second frame 63 is fixed by screws to the opening 71a side of the main body frame 71, that is, the rear face side. The portion of the second frame 63 that supports the second lead screw 62 is inserted into the main body frame 71 from the opening 71a side of the main body frame 71. Therefore, the second drive unit 60 can be mounted to the main body frame 71 in a state in which the second drive unit 60 is assembled (a state in which the second frame 63 supports the second drive motor 61 and the second lead screw 62), which simplifies the assembly work. Also, since there is no need for a hole or cut-out for inserting the second drive unit 60 into the main body frame 71 to be provided on the left side of the main body frame 71, this prevents a decrease in the strength of the main body frame 71.

The reason the opening 71a is provided on the rear face of the main body frame 71 is that it facilitates the work of installing the second support frame 20, the third support frame 30, and so forth in the main body frame 71. For instance, part of the first movement range M1 of the second lens group G2 in the Z-axis direction overlaps part of the second movement range M2 of the third lens group G3 in the Z-axis direction (see FIG. 3B). Accordingly, the main body frame 71 must have in its interior a space that includes the first movement range M1 of the second lens group G2 and the second movement range M2 of the third lens group G3, and the members fixed to the main body frame 71 cannot be disposed between the second support frame 20 and the third support frame 30. In other words, a large space can be ensured by providing the opening 71a on the rear face side.

In contrast, when the opening 71a of the main body frame 71 is provided on the top or bottom face of the main body frame 71, for example, the surface area of the opening 71a is smaller and the depth of the internal space from the opening 71a is less, which makes it more difficult to install the first guide shaft 59 and so forth in the main body frame 71.

Furthermore, providing the opening 71a on the rear face side allows the first guide shaft 59 and the second guide shaft 69 to be fixed to the top plate 76 and the bottom plate 79, respectively, of the main body frame 71. Accordingly, there is no need to fix the first guide shaft 59 and the second guide shaft 69 to the main body frame 71 at a middle location within the main body frame 71 (such as the first movement range M1 of the second lens group G2 or the second movement range M2 of the third lens group G3), and a large first movement range M1 and second movement range M2 can be ensured.

Providing the opening 71a to the rear face as in the above embodiment makes the assembly work easier. This assembly work will be discussed below.

When assembly work is taken into account, the opening 71a is preferably provided to the widest of the faces of the main body frame 71. For example, in the case of the lens barrel 3, the opening 71a is preferably provided to the rear face and/or the front face.

(9) Lens Drive Device

The lens drive device 40 supports the fourth lens group G4 to be movable within a plane that is perpendicular to the second optical axis A2. More specifically, the lens drive device 40 has the master flange 42, a fourth support frame 41, a rotary shaft 44, a limiting pin 46, a first sliding shaft 48a, a second sliding shaft 48b, a first coil 49a, and a second coil 49b.

The fourth support frame 41 is disposed movably in the X-axis direction and Y-axis direction with respect to the master flange 42, and supports the fourth lens group G4. The fourth support frame 41 has a slot 43 that extends in the X-axis direction when viewed in the Z-axis direction. The rotary shaft 44 is fixed to the master flange 42. The rotary shaft 44 has a center axis that is substantially parallel with the Z-axis direction, and protrudes from the master flange 42 toward the fourth support frame 41. The rotary shaft 44 is inserted into the slot 43. The fourth support frame 41 is guided in the X-axis direction with respect to the master flange 42 by the rotary shaft 44 and the slot 43, and the fourth support frame 41 is rotatable around the rotary shaft 44 with respect to the master flange 42 by the rotary shaft 44 and the slot 43.

The limiting pin 46 is fixed to the master flange 42, and protrudes from the master flange 42 toward the fourth support frame 41. The center axis of the limiting pin 46 is substantially parallel with the Z-axis direction. The limiting pin 46 is inserted in a limiting hole 45 provided to the fourth support frame 41. The limiting pin 46 and the limiting hole 45 determine the movement range of the fourth support frame 41 with respect to the master flange 42.

The fourth support frame 41 has a first bearing 47a and a second bearing 47b for limiting the movement of the fourth support frame 41 in the Z-axis direction. Also, the first sliding shaft 48a and the second sliding shaft 48b are fixed to the master flange 42. The first sliding shaft 48a and the second sliding shaft 48b are parallel to a plane that is perpendicular to the second optical axis A2. The first bearing 47a is disposed to sandwich the first sliding shaft 48a in the Z-axis direction. The second bearing 47b is disposed to sandwich the second sliding shaft 48b in the Z-axis direction. The first bearing 47a, the first sliding shaft 48a, the second bearing 47b, and the second sliding shaft 48b limit the movement of the fourth support frame 41 in the Z-axis direction with respect to the master flange 42, and allow the movement of the fourth support frame 41 within a plane perpendicular to the second optical axis A2.

The first sliding shaft 48a is disposed at an angle to the Y-axis. The first sliding shaft 48a is also disposed at an angle to the X-axis. Specifically, the angle formed by the first sliding shaft 48a and the Y-axis is greater than 0 degrees and less than 90 degrees. The first sliding shaft 48a is fixed to the rear face of the master flange 42 and a face (right face) that is substantially perpendicular to the rear face of the master flange 42. Consequently, the first sliding shaft 48a can be disposed in a smaller space than the second sliding shaft 48b.

The first coil 49a and the second coil 49b are fixed to the master flange 42. First and second magnets (not shown) are fixed to the fourth support frame 41. The first coil 49a is disposed to be opposite the first magnet, and the second coil 49b is disposed to be opposite the second magnet. When power is supplied to the first coil 49a and second coil 49b, electromagnetic forces are generated in the X-axis direction and Y-axis direction. These electromagnetic forces drive the fourth support frame 41 in the X-axis direction and Y-axis direction with respect to the master flange 42. The first and second magnets may be fixed to the master flange 42, and the first coil 49a and the second coil 49b may be fixed to the fourth support frame 41.

For example, the fourth lens group G4 is driven in the X-axis direction and Y-axis direction by the lens drive device 40 according to the amount of shaking in the pitch direction (around the X-axis) and yaw direction (around the Z-axis) detected by a shake detection sensor (not shown). This allows the position of the optical image of a subject to be adjusted according to shaking of the digital camera 1, so image blurring can be corrected.

Assembly Work

The work of installing the second support frame 20 and the third support frame 30 in the main body frame 71 will now be described through reference to FIGS. 13A to 13F. FIGS. 13A to 13F are diagrams illustrating the steps of installing the second support frame 20 and the third support frame 30 in the main body frame 71.

First, the first guide shaft 59 and the second guide shaft 69 are inserted from the top face side of the main body frame 71 (FIG. 13A). Here, to ensure enough space to insert the second support frame 20 and the third support frame 30, the first guide shaft 59 and the second guide shaft 69 are pre-inserted about half-way. Then, the second support frame 20 is inserted inside the main body frame 71 through the opening 71a in the main body frame 71 (FIG. 13B). After insertion of the second support frame 20, the first guide shaft 59 is inserted into the first guide portion 23 of the second support frame 20, and the second guide shaft 69 is inserted into the second guide portion 24 (FIG. 13C). The third support frame 30 is then inserted inside the main body frame 71 through the opening 71a in the main body frame 71 (FIG. 13D). After insertion of the third support frame 30, the first guide shaft 59 is inserted into the fourth guide portion 34 of the third support frame 30, and the second guide shaft 69 is inserted into the third guide portion 33 (FIG. 13E). The first guide shaft 59 and the second guide shaft 69 are inserted up to the bottom plate 79 of the main body frame 71, and the first guide shaft 59 and the second guide shaft 69 are fixed to the main body frame 71 (FIG. 13F).

In a state in which the first guide shaft 59 and the second guide shaft 69 have been fixed to the main body frame 71, the first guide shaft 59 and the second guide shaft 69 protrude from the top face of the main body frame 71. A first positioning hole 19a and a second positioning hole 19b are provided to the first support frame 10. In disposing the first support frame 10 on the top face of the main body frame 71, as shown in FIG. 4, the first guide shaft 59 is fitted into the first positioning hole 19a. Moreover, as shown in FIG. 6, the second guide shaft 69 is fitted into the second positioning hole 19b. Therefore, the first support frame 10 is positioned by the first guide shaft 59 and the second guide shaft 69. In this positioned state, the first support frame 10 is fixed to the main body frame 71.

As discussed above, the first support frame 10, the second support frame 20, and the third support frame 30 are positioned by the same members (more specifically, the first guide shaft 59 and the second guide shaft 69). Therefore, the positioning accuracy of the first support frame 10, the second support frame 20, and the third support frame 30 can be increased.

Operation of Digital Camera

The operation of the digital camera 1 will be described.

(1) Zoom Operation During Image Capture

When the power is on, the imaging optical system O is set to the wide angle end (the state shown in FIG. 10), for example. When the zoom adjustment lever 7 is operated to the telephoto side, the second support frame 20 and the third support frame 30 are driven in the Z-axis direction by the first drive unit 50 and the second drive unit 60 according to the rotational angle and operation duration of the zoom adjustment lever 7. More specifically, when the first lead screw 52 is rotationally driven by the first drive motor 51 of the first drive unit 50, the second support frame 20 moves along the second optical axis A2 to the first lens group G1 side (see FIG. 1, for example). When the second lead screw 62 is rotationally driven by the second drive motor 61 of the second drive unit 60, the third support frame 30 moves along the second optical axis A2 to the first lens group G1 side (see FIG. 6, for example). The second support frame 20 moves linearly from the wide angle end toward the telephoto end, but the third support frame 30 turns back to the imaging unit 90 side midway, and again moves to the first lens group G1 side (see FIG. 3B, for example).

When the zoom adjustment lever 7 is operated to the wide angle side, the second support frame 20 is driven to the imaging unit 90 side by the first drive unit 50 according to the rotational angle and operation duration of the zoom adjustment lever 7, and the third support frame 30 is driven to the imaging unit 90 side by the second drive unit 60.

Thus, when the second lens group G2 and the third lens group G3 move along the second optical axis A2, the zoom magnification of the imaging optical system O increases.

Features

The features of the lens barrel 3 described above are compiled below:

(1) As shown in FIGS. 6 and 7, the third support frame 30 has the third support frame main body 31 and the first protruding part 35. The third support frame main body 31 has a first end part 31a disposed at an end in the Y-axis direction (an example of a second direction parallel to the first optical axis A1). The first protruding part 35 is integrally formed with the first end part 31a as a one-piece, unitary member and extends from the third support frame main body 31 in the Z-axis direction away from the first lens group G1. However, it will be appreciated by those skilled in the art that the particular union of the first protruding part 35 and the first end part 31a may be readily modified in view of the disclosure contained herein to optimally accommodate different types of connections. For example, as shown in FIG. 16, the first protruding part 35 may be connected to the first end part 31a by an adhesive bonding, fusion welding, or the like.

In FIG. 11, light that passes through the first lens group G1 is supposed to pass through the third lens group G3 housed in the lens case 70. However, as shown in FIG. 11, for example, some of the light that passes through the first lens group G1 does not pass through the third lens group G3, but instead goes through a gap formed between the third support frame 30 and the lens case 70. This unnecessary or random light that passes through the gap is the source of camera flare and ghosting.

However, with this lens barrel 3, since the length C1 of the first end part 31a and the first protruding part 35 is larger than the dimension C2 of the gap formed between the first end part 31a and the lens case 70, any unnecessary or random light that passes between the third support frame 30 and the lens case 70 is deflected back and forth between the first end part 31a and first protruding part 35 and the rear plate 72 of the lens case 70 until substantially attenuated.

Thus, with this lens barrel 3, there is less unnecessary or random light landing on the imaging element 91.

(2) As shown in FIG. 7, the lens case 70 includes the main body frame 71 with the opening 71a that accommodates the movable third support frame 30. The rear plate 72 is removably mounted to the main body frame 71 and arranged to cover the opening 71a. Since the rear plate 72 is removably mounted to the main body frame 71, it is difficult to accurately arrange the rear plate 72 close to the third support frame 30. As a result, the dimension C2 between the rear plate 72 and the third support frame 30 ends up being relatively large. For example, the dimension C2 ends up being larger than the dimension C4 between the front plate 74 and the third support frame 30. Therefore, as shown in FIG. 11, the amount of light that passes between the rear plate 72 and the third support frame 30 is greater than the amount of light passing through other gaps.

As shown in FIG. 7, however, since the first protruding part 35 is arranged adjacent to the rear plate 72, the light that passes between the rear plate 72 and the third support frame 30 is attenuated by the first protruding part 35.

Also, since the rear plate 72 is thinner than the front plate 74, the rear plate 72 tends to deformed more easily than the front plate 74. Accordingly, the amount of light that passes between the rear plate 72 and the third support frame 30 tends to vary, and if the rear plate 72 should bend to the outside, for example, the amount of unnecessary light passing through will increase.

However, since the first protruding part 35 is arranged adjacent to the rear plate 72, even if the rear plate 72 deforms and the gap gets larger between the rear plate 72 and the third support frame 30, the light that passes between the rear plate 72 and the third support frame 30 will be attenuated by the first protruding part 35.

(3) As shown in FIG. 6, the first protruding part 35 extends in the X-axis direction. More specifically, the dimension C3 of the first protruding part 35 in the X-axis direction is larger than the dimension C1 of the first protruding part 35 in the Z-axis direction. Consequently, even if unnecessary light spreads out in the X-axis direction, the light passing between the third support frame 30 and the lens case 70 will still be attenuated by the first protruding part 35.

Also, a small of amount of unnecessary light gathers in remote regions away from the second optical axis A2. In other words, unnecessary light tends to pass through the gaps formed close to the second optical axis A2 when viewed from the Y-axis direction.

However, as shown in FIGS. 6 and 7, since the first protruding part 35 overlaps the second optical axis A2 when viewed in the Y-axis direction, the unnecessary light will be attenuated by the first protruding part 35.

(4) As shown in FIGS. 6 and 7, there is further provided the second lens group G2, which is movably disposed between the first lens group G1 and the third lens group G3 in the Z-axis direction. The second lens group G2 is movable in the Z-axis direction within the first movement range M1, and the third lens group G3 is movable in the Z-axis direction within the second movement range M2. Part of the first movement range M1 overlaps part of the second movement range M2.

Thus, because both the second lens group G2 and the third lens group G3 are constructed to move in the Z-axis direction, a large spaces must be provided inside the lens case 70 in order to facilitate movement of both the second lens group G2 and the third lens group G3 can easily. Accordingly, unnecessary light tends to pass through gaps between these members. Therefore, the first protruding part 35 is provided to reducing internal reflection and scattering of unnecessary light.

(5) As shown in FIGS. 6 and 7, the first housing portion 75 of the lens case 70 is arranged at a position corresponding to the first protruding part 35 in the Z-axis direction. The first housing portion 75 is cable of housing the first protruding part 35. More specifically, since the first housing portion 75 has the first groove 75a to house the first protruding part 35, even if the third support frame 30 moves in the Z-axis direction and approaches the bottom plate 79 of the lens case 70, the first protruding part 35 will be housed in the first housing portion 75. Consequently, the effect of random light can be reduced while preventing the first protruding part 35 from making the lens case 70 unnecessarily larger.

(6) As shown in FIG. 6, the third support frame main body 31 has the second end part 31b disposed at an end in the X-axis direction. The third support frame 30 has the second protruding part 36 that is provided to the second end part 31b and protrudes from the third support frame main body 31 in the Z-axis direction (more precisely, on the Z-axis direction negative side, which is the opposite side from the first lens group G1). Since the second protruding part 36 is thus provided to the third support frame 30 in addition to the first protruding part 35, light that passes between the third support frame 30 and the lens case 70 can be attenuated by the first protruding part 35 and the second protruding part 36, which further enhances the effect of reducing unnecessary light.

In particular, since the second support frame 20 has a large cut-out in order to house the third guide portion 33, there is the possibility that unnecessary light will escape from the third support frame 30 through the gap around the third guide portion 33. However, since the second protruding part 36 is provided to the second end part, unnecessary light that passes through the gap around the third guide portion 33 can be effectively attenuated.

Also, as shown in FIG. 6, the second housing portion 77 of the lens case 70 is disposed at a position corresponding to the second protruding part 36 in the Z-axis direction, and is provided to be able to house the second protruding part 36. More specifically, since the second housing portion 77 has the second groove 77a provided to be able to house the second protruding part 36, even if the third support frame 30 moves in the Z-axis direction and approaches the bottom plate 79, the second protruding part 36 will be housed in the second housing portion 77. This reduces the effect of unnecessary light while preventing the second protruding part 36 from making the lens case 70 larger.

(8) As shown in FIG. 9A, the first lens L1 has the first side face L1A, the second side face L1B, the third side face L1C, and the fourth side face L1D. The first side face L1A is flat. The second side face L1B is a flat face disposed on the opposite side from the first side face L1A, with the first optical axis A1 sandwiched in between. The third side face L1C is disposed between the first side face L1A and the second side face L1B, and forms an arc whose center is the first optical axis A1. The fourth side face L1D is disposed on the opposite side form the third side face L1C, with the first optical axis A1 sandwiched in between, and forms an arc whose center is the first optical axis A1.

Meanwhile, the first support frame 10 has the first wall portion 14A, the second wall portion 14B, the third wall portion 14C, and the fourth wall portion 14D. The first wall portion 14A is disposed to be opposite to the first side face L1A in the Z-axis direction. The second wall portion 14B is disposed to be opposite to the second side face L1B in the Z-axis direction. The third wall portion 14C is disposed to be opposite to the third side face L1C. The fourth wall portion 14D is disposed to be opposite to the fourth side face L1D. The first wall portion 14A has a first cut-out 17 that passes through in the Z-axis direction. The third wall portion 14C has a second cut-out 16A that passes through in the X-axis direction. The fourth wall portion 14D has a third cut-out 16B that passes through in the H1 direction (see FIG. 9B) and the fourth cut-out 16C that passes through in the H2 direction (see FIG. 9B).

With this lens support structure, since the first support frame 10 has the first cut-out 17, the second cut-out 16A, the third cut-out 16B, and the fourth cut-out 16C, in positioning of the first lens L1, the orientation of the first lens L1 can be adjusted by pressing the first lens L1 against the second wall portion 14B with the first adjusting rod B1, which is an adjusting member. Furthermore, if the three second adjusting rods B2 are inserted in the second cut-out 16A, the third cut-out 16B, and the fourth cut-out 16C, alignment of the first lens L1 with respect to the first support frame 10 can be carried out easily.

In particular, as shown in FIG. 9D, the position of the first lens L1 can be adjusted while the first lens L1 is held down in the Y-axis direction by pressing the taper faces B2a of the second adjusting rods B2 against the edges on the convex face LIE side of the fourth side face L1D and the third side face L1C. Therefore, there is no need to hold the first lens L1 down in the Y-axis direction with any member other than the second adjusting rods B2, which facilitates work.

Also, since the second wall portion 14B comes into contact with the second side face L1B, the first lens L1 can be simply positioned in the Z-axis direction, and it is easy to adjust the position of the first lens L1 in the X-axis direction. Furthermore, since the second cut-out 16A passes through in the X-axis direction, the position of the first lens L1 in the X-axis direction can be easily adjusted by inserting the second adjusting rod B2 through the second cut-out 16A.

Also, as shown in FIG. 9C, the second cut-out 16A is disposed at a position that overlaps the plane P1, which is parallel to the X-axis direction and includes the first optical axis A1. The third and fourth cut-outs 16B and 16C are disposed on both sides with the plane P1 in between. Consequently, the first lens L1 can be supported at three or more points by inserting the three second adjusting rods B2 via the second cut-out 16A, the third cut-out 16B, and the fourth cut-out 16C. Consequently, the arc-shaped third side face L1C and fourth side face L1D can be efficiently supported, and the position of the first lens L1 with respect to the first support frame 10 can be easily adjusted.

Furthermore, since the second wall portion 14B, which has no cut-out, is disposed on the same side as the third lens L3, no extra gap is formed between the lens case 70 and the first support frame 10 that would otherwise be produced by a cut-out. Therefore, unnecessary light is prevented from being incident from around the second wall portion 14B.

### OTHER EXAMPLE EMBODIMENTS

The lens drive mechanism according to the present invention is not limited to the above embodiment, and various modifications and changes are possible without departing from the gist of the present invention. Components that have substantially the same function as the components in the embodiment given above will be numbered the same below, and will not be described again in detail.

(a) The lens barrel 3 discussed above can be applied not only to a digital camera, but also to a mobile telephone, a PDA (personal digital assistant), or another such imaging device.

(b) The first drive unit 50 and the second drive unit 60 may be another kind of drive unit, such as an electromagnetic actuator.

(c) The first groove 75a and the second groove 77a were grooves (also called cut-outs) formed on the opening 71a side of the bottom plate 79, but may instead be holes formed in the bottom plate 79.

(d) The term “lens barrel” is not limited to a cylindrical barrel, and is a concept that encompasses a rectangular barrel as in the embodiment.

(e) What is important about the first protruding part 35 and the second protruding part 36 is that they will be able to enhance the attenuation of unnecessary light, and the position and shape of the first protruding part 35 and the second protruding part 36 are not limited to what was given in the embodiment above.

For example, as shown in FIGS. 15A and 15B, the first protruding part 35 may protrude from the third support frame main body 31 to the Z-axis direction positive side (the first lens group G1 side), or may protrude from the third support frame main body 31 to the Z-axis positive and negative sides. When the reduction of unnecessary light is taken into account, it preferably protrudes to the Z-axis positive and negative sides. When the interference with the other members is taken into account, it preferably protrudes to the Z-axis positive or negative side.

The first protruding part 35 may be provided only on the front face side (Y-axis direction positive side) of the third support frame 30, or may be provided on both the front face side (Y-axis direction positive side) and the rear face side (Y-axis direction negative side).

The positional relation between the first protruding part 35 and its surrounding components is not limited to the relation of the dimensions C1, C2, and C3. The first protruding part 35 need only protrude from the third support frame main body 31 in the Z-axis direction.

Furthermore, in the above embodiment, the first protruding part 35 and the second protruding part 36 were integral portions of the third support frame main body 31, but the first protruding part 35 and the second protruding part 36 may instead be separate members from the third support frame main body 31. For example, as shown in FIG. 16, the first protruding part 35 and the second protruding part 36 may be a light blocking sheet 236 (an example of the first protruding part and the second protruding part) that is fixed to the third support frame main body 31. The light blocking sheet 236 protrudes from the third support frame main body 31 in the Z-axis direction. Again with this constitution, the effect of unnecessary light can be reduced.

(f) In the above embodiment, the first protruding part 35 overlapped the first optical axis A1 when viewed in the Y-axis direction, but the relation between the first protruding part 35 and the first optical axis A1 is not limited to what was given in the embodiment above. For example, unnecessary light can be attenuated by the first protruding part 35 as long as the first protruding part 35 is disposed near the first optical axis A1 when viewed in the Y-axis direction.

(g) The constitution of the imaging optical system O is not limited to what was given in the embodiment above. For example, the first to fourth lens groups G1 to G4 may each consist of a single lens, or may consist of a plurality of lenses. For example, the third lens group G3 was made up on just the eighth lens L8, but the third lens group G3 may be made up of a plurality of lenses.

(h) When reducing the effect of unnecessary light is taken into account, the rear plate 72 disposed adjacent to the first protruding part 35 is preferably thinner than the front plate 74, but the thickness relation is not limited to what was given in the embodiment above. For example, the rear plate 72 may be the same thickness as the front plate 74, or may be thicker than the front plate 74. Also, in the above embodiment the first protruding part 35 was disposed adjacent to the rear plate 72, but the first protruding part 35 may instead be disposed adjacent to the front plate 74.

(i) In the above embodiment, part of the first movement range M1 overlaps part of the second movement range M2, but even if part of the first movement range M1 does not overlap the second movement range M2, the first protruding part 35 will still have the effect of attenuating unnecessary light.

(j) In the above embodiment, the first housing portion 75 and the second housing portion 77 were provided, but the effect of unnecessary light can be reduced even though there is no portion that houses the first protruding part 35 and the second protruding part 36. Also, the first housing portion 75 may have a configuration such that it can house the first protruding part 35, and may have a hole rather than a cut-out or a depression. The second housing portion 77 may have a configuration such that it can house the second protruding part 36, and may have a hole rather than a cut-out or a depression.

(k) The position and shape of the first cut-out 17, the second cut-out 16A, the third cut-out 16B, and the fourth cut-out 16C are not limited to what was discussed in the above embodiment. For example, the third and fourth cut-outs 16B and 16C were formed in the first support frame main body 11 in the above embodiment, but one or more cut-outs may be provided to the fourth wall portion 14D. For example, the position of the first lens L1 can be easily adjusted just as in the above embodiment if the first cut-out 17, the second cut-out 16A, and the third cut-out 16B are provided.

Additional Features

The lens barrel described above also encompasses the following features:

Addition 1

A lens support structure comprises a first lens element and a first support frame. The first lens element includes a first optical axis, a first side face including a flat face, a second side face disposed on the opposite side of the first optical axis from the first side face and including a flat face, a third face disposed between the first and second side faces and forming an arc whose center is the first optical axis, and fourth side face disposed on the opposite side of the first optical axis from the third side face and forming an arc whose center is the first optical axis. The first support frame supports the first lens element, and has a first wall portion disposed to be opposite to the first side face in a first passing direction perpendicular to the first optical axis, a second wall portion disposed to be opposite to the second side face in the first passing direction, a third wall portion disposed to be opposite to the third side face, and a fourth wall portion disposed to be opposite to the fourth side face. The first wall portion has a first cut-out that passes through in the first passing direction. The third wall portion has a second cut-out that passes through in a second passing direction perpendicular to the first optical axis. The fourth wall portion has a third cut-out that passes through in a third passing direction perpendicular to the first optical axis.

Addition 2

A lens support structure wherein the second wall portion is disposed to be substantially parallel to the second side face.

Addition 3

A lens support structure wherein the second passing direction is perpendicular to the first optical axis and the first passing direction.

Addition 4

A lens support structure wherein the second cut-out is disposed at a position that overlaps a plane that includes the first optical axis and is parallel to the third passing direction.

Addition 5

A lens support structure wherein the fourth wall portion has a fourth cut-out that passes through in a fourth passing direction perpendicular to the first optical axis.

Addition 6

A lens support structure wherein the third and fourth cut-outs are disposed on both sides with a plane including the first optical axis and parallel to the first passing direction in between.

Addition 7

A lens support structure wherein the third and fourth cut-outs are disposed at positions that are shifted from a position on the opposite side from the second cut-out with the first optical axis sandwiched in between.

Addition 8

A lens support structure further comprising a bending optical element and a second lens element. The bending optical element is supported by the first lens element, and guides light that passes through the first lens element to the first passing direction. The second lens element is supported by the first support frame, has a second optical axis parallel to the first passing direction. The light guided by the bending optical element in the first passing direction passes through the second lens element. The second wall portion is disposed on the same side as the second lens element with respect to a plane that includes the first optical axis and is perpendicular to the first passing direction.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having,” “with” and their derivatives. Also, the term “part,” “section,” “portion,” “member,” or “element” when used in the singular can have the dual meaning of a single part or a plurality of parts.

The term “configured” as used herein to describe a component, section or part of a device implies the existence of other unclaimed or unmentioned components, sections or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the digital camera, it will be apparent to those skilled in the art from this disclosure that various changes and modifications can be made herein without departing from the scope of the invention as defined in the appended claims. Furthermore, the foregoing descriptions of the embodiments according to the digital camera are provided for illustration only, and not for the purpose of limiting the invention as defined by the appended claims and their equivalents. Thus, the scope of the invention is not limited to the disclosed embodiments.

What is claimed is:

1. A lens barrel structure, comprising:
a lens case structure;
a first lens group fixedly coupled to the lens case structure and including a first optical axis and a second optical axis, the first lens group being configured and arranged to guide light incident along the first optical axis from a subject to a first direction substantially parallel to the second optical axis that intersects with the first optical axis;
a movable lens group housed in the lens case structure; and
a movable support frame housed in the lens case structure and including a support frame main body having a first end part configured to movably support the movable lens group and extending in a second direction substantially parallel to the first optical axis and a first protruding part coupled to the first end part and extending along the first direction, the movable support frame being movable with respect to the lens case structure along the first direction.

2. The lens barrel structure according to claim 1, wherein
a longitudinal side of the first protruding part is arranged to extend along the longitudinal direction of the movable support frame.

3. The lens barrel structure according to claim 2, wherein
the first protruding part is disposed between the lens case structure and a portion of the longitudinal side of the movable support frame.

4. The lens barrel structure according to claim 1, wherein
a longitudinal side of the first protruding part is arranged to extend along the longitudinal direction of the first end part.

5. The lens barrel structure according to claim 4, wherein
the first protruding part is disposed between the lens case structure and a portion of the longitudinal side of the first end part.

6. The lens barrel structure according to claim 1, wherein
combined sizes of the first end part and the first protruding part in the first direction is larger than a dimension of a gap formed in the second direction between the lens case structure and the first end part.

7. The lens barrel structure according to claim 1, wherein
the support frame main body further has a second end part that extends along a third direction perpendicular to the first and second directions; and
the movable support frame further includes a second protruding part coupled to the second end part and extends along the first direction.

8. The lens barrel structure according to claim 1, wherein
the lens case structure includes a main body frame having an opening that accommodates the movable support frame and a cover member removably mounted to the main body frame to cover the opening, the first protruding part being disposed adjacent to the cover member.

9. The lens barrel structure according to claim 1, wherein
the lens case structure includes a first plate and a second plate oppositely facing and substantially parallel to the first plate, the movable support frame being disposed between and perpendicular to the first and second plates.

10. The lens barrel structure according to claim 9, wherein
the first protruding part is arranged to extend in a third direction perpendicular to the first and second directions.

11. The lens barrel structure according to claim 10, wherein
a size of the first protruding part in the third direction is larger than a size of the first protruding part in the first direction.

12. The lens barrel structure according to claim 1, wherein
the first protruding part is arranged to extend along the first direction towards the first lens group by way of a upper side of the support frame main body.

13. The lens barrel structure according to claim 1, wherein
the first protruding part is arranged to extend along the first direction away from the first lens group by way of a lower side of the support frame main body.

14. The lens barrel structure according to claim 1, further comprising
a second lens group movably disposed in the first direction between the first lens group and the movable lens group.

15. The lens barrel structure according to claim 14, wherein
the second lens group is configured to move in the first direction within a first movement range and the movable lens group is configured to move in the first direction within a second movement range, a part of the first movement range overlaps with a part of the second movement range.

16. The lens barrel structure according to claim 1, wherein
the lens case structure includes a first aperture arranged to receive and accommodate the first protruding part in the first direction.

17. The lens barrel structure according to claim 1, wherein
the support frame main body further has a third end part that extends along a third direction perpendicular to the first and second directions, a size of the third end part in the first direction is smaller than combined sizes of the first end part and the first protruding part in the first direction.

18. The lens barrel structure according to claim 7, further comprising
a guide shaft fixed to the lens case structure and configured to guide the movable support frame in the first direction

19. The lens barrel structure according to claim 18, wherein
the movable support frame further includes a sliding part that projects from the support frame main body towards the first lens group and is slidably mounted on the guide shaft.

20. The lens barrel structure according to claim 19, wherein
the sliding part and the second protruding part are disposed on the same side of the second optical axis.

21. The lens barrel structure according to claim 7, wherein
the lens case structure includes a second aperture arranged to receive and accommodate the second protruding part in the first direction.

22. The lens barrel structure according to claim 1, wherein
the movable lens group has only a single lens.

23. The lens barrel structure according to claim 9, wherein
the second plate is thinner that the first plate, and the first protruding part is disposed adjacent to the second plate.

24. The lens barrel structure according to claim 7, wherein
combined sizes of the second end part and the second protruding part in the first direction is smaller than combined sizes of the first end part and the first protruding part in the first direction.

25. The lens barrel structure according to claim 24, wherein
the support frame main body further has a third end part that extends along the third direction perpendicular to the first and second directions, a size of the third end part in the first direction is smaller than combined sizes of the first end part and the first protruding part in the first direction.

26. The lens barrel structure according to claim 1, wherein
the first protruding part overlaps a part of the second optical axis when viewed in the second direction.

27. The lens barrel structure according to claim 7, wherein
the second protruding part overlaps a part of the second optical axis when viewed in the third direction.
